(19) United States
(12) Patent Application Publication
(10) Pub. No.: US 2026/0365427 A1
(43) Pub. Date: Nov. 19, 2026

(54) HIGH-DENSITY AUTOMATED STORAGE AND RETRIEVAL SYSTEM WITH VERTICAL CARRIER MOVEMENT

(71) Applicant: CARNEGIE MELLON UNIVERSITY, Pittsburgh, PA (US)

(72) Inventors: Herman Herman, Pittsburgh, PA (US); Gabriel Goldman, Pittsburgh, PA (US)

(73) Assignee: CARNEGIE MELLON UNIVERSITY, Pittsburgh, PA (US)

(21) Appl. No.: 19/212,106

(22) Filed: May 19, 2025

(51) Int. Cl. B65G 1/06

(52) U.S. Cl. CPC B65G 1/065

(57) ABSTRACT

Disclosed herein are various configurations of a high-density storage system comprising a plurality of layers, each layer comprising a plurality of rows for storing a plurality of coupled totes and one or more robotic carriers located on opposite ends of each layer, each carrier being multiple rows wide, each carrier capable of retrieving totes from a row in the layer, depositing a tote into a row or oral in a layer and shifting totes from one row to another within the layer.

### BACKGROUND

Companies are pushing to maximize the storage density and efficiency of automated storage and retrieval systems (AS/RS) in their order fulfillment process. AS/RS systems use automated carriers that typically move either between or on top of structures that hold products or totes filled with products. In the case of systems where carriers move in between aisles of products and/or totes, there is a limit as to how dense the system can be in that the space required for the carrier movement reduces the overall potential storage density of the system.

Some systems maximize density by stacking products or totes vertically, which maximizes storage density, but has potentially lower efficiency when retrieving products or totes that are buried lower in the stacks. In one case, a gantry services a range of totes that are stacked on the floor, which minimizes infrastructure but ultimately has a limit on performance based on a limited number of gantry arms overlapping the same workspace. In another case, the system stacks totes vertically within a raised structure. Retrieval robots lift the totes from the top one-by-one. This results in a limit on performance to retrieve totes that are lower in the stack with each lift taking a longer amount of time proportional to the height of the tote stack or product being lifted.

### SUMMARY OF THE INVENTION

The embodiments described herein provide the capability for a highly dense storage solution while also providing a high level of performance, thereby improving both density and speed of retrieval over prior art systems. Instead of stacking the totes vertically (which has an inherent height limit due to the mechanical limit and the weight of the totes), the totes are arranged in horizontal layers of rows within a passive supporting structure. Unlike other systems, the totes are mechanically coupled to allow for a row of horizontally connected totes to be pulled and/or pushed together as a unit by pulling or pushing one or more totes on the end of a row, which will also pull or push all other totes within that same row that are coupled together. This arrangement allows any tote within a row to be retrieved by repeatedly pulling and decoupling the outer tote from the row until the tote-of-interest is retrieved. It also allows for the easy storage of totes. A tote could be stored in this AS/RS system simply by pushing a tote into a row that has an empty spot. As that tote is pushed into that row, it will automatically couple itself longitudinally when it comes into contact with the totes that are already in that row. This efficient storage approach could also be used to store totes that were removed from a row to access a tote-of-interest initially located on the interior of a row for retrieval.

The described embodiments store totes within a layered support structure. This structure supports the weight of all totes as well as providing rows within the structure in which totes can be stored. The totes are placed into the structure rows through a horizontal motion in a similar manner to other rack-based storage solutions. The novel storage structure allows for a high number of totes to be stored in a single row, whereas more standard rack structures allow for only a small number of totes or packages to be stored on a given shelf, because there is no efficient way to access totes that are located deep in the row. The described embodiments are able to retrieve totes from anywhere within a row upon request with a high level of performance in comparison to other high-density storage solutions. This is possible since all totes, no matter how deep they are located in the row, could be accessed just by pulling on the outside totes until the tote-of-interest is at the edge of the row. Pulling on the outer tote or totes will also pull all the other totes that are coupled, thereto allowing the tote-of-interest to be pulled toward the end of the row for retrieval.

A series of robotic carriers are responsible for moving totes into and out of the storage system and for manipulating totes within the storage system. The robotic carriers can pull a tote at the end of a row onto the carrier, causing all coupled totes in the row to move toward the carrier, receive totes pushed out of a row and shift totes to different position on the carrier. Pairs of carriers located on opposite sides of the storage structure can operate in tandem to circulate totes between two rows until a tote-of-interest is located on one of the carriers. The robotic carrier can move horizontally with respect to the storage structure, vertically with respect to the storage structure, or both horizontally and vertically. A carrier having a tote-of-interest thereon can move to an exit point of the storage structure and deposit the totes there, as well as picking up a tote from an intake point of the storage structure to store the tote in a row.

The totes may be configured with three different types of drives for moving the totes. A constant velocity drive mechanism is responsible for moving the totes into and out of the rows at a constant velocity. An acceleration drive mechanism is responsible for accelerating a tote from the carrier into a row such that it “catches up” to the tote at the end of the row and couples with it, as the row is moving away at a constant velocity. The third type of drive is a side shift drive mechanism that is responsible for shifting the totes on the carrier from a source row to a destination row.

In other aspects of the invention, different features for improving the efficiency of the storage structure are disclosed. These include, for example, various configurations of the three different types of drives, a cantilevered area in the storage structure which allows the continuous drive to be positioned between the layers, improvements to the storage structure to optimize the intake of totes into the system and the output of totes from the system and improvements to the latching mechanism by which the totes in each of the rows are connected to each other.

In embodiments claimed herein, the totes are configured to move vertically with respect to the storage structure. Totes-of-interest can be moved to an exit point of the storage structure, which maybe one of one or more conveyors located at one or more levels of the storage structure, or to a ground-based automated mobile robot mobile robot. In a variation of the embodiment wherein carriers are configured to move vertically, a vertically-movable platform may be provided having robotic carriers moving horizontally thereon.

### BRIEF DESCRIPTION OF THE DRAWINGS

FIG. 1 is an illustration showing an exemplary configuration of the storage system of the present invention.

FIG. 2 shows more detail of a portion of the storage system shown in FIG. 1.

FIGS. 3(A-L) is a series of schematic diagrams showing the pseudo-continuous movement of the totes as they are shifted from one row to another.

FIG. 4 is a transparent illustration of a tote in accordance with the present invention.

FIG. 5 shows one embodiment of a tote coupling mechanism.

FIG. 6 is an illustration of one embodiment of the carrier.

FIG. 7 is an illustration of a constant velocity drive mechanism of a robotic carrier.

FIG. 8 is an illustration of the lifting mechanism which is part of the constant velocity drive mechanism.

FIGS. 9(A-B) are illustrations showing a carrier which is moved underneath a cantilevered portion of a row in the storage structure.

FIG. 10 is an illustration of the acceleration drive mechanism.

FIG. 11 is an illustration of internal portions of the acceleration drive mechanism.

FIG. 12 is a side view of the internal structure of the acceleration drive mechanism, showing the configuration of the drive belt.

FIG. 13 is an illustration of the side shift mechanism.

FIG. 14 is an illustration of a portion of the storage structure showing the area where the intake/output structure is located.

FIG. 15 is an illustration showing the intake/output structure in situ on the storage structure.

FIG. 16 is an illustration of an input ramp which is part of the intake/output structure.

FIGS. 17(A-B) are illustrations of the lifting mechanism for lifting a tote from the picking area to an input ramp.

FIG. 18 is a top view of a picking station and an intake and output ramp.

FIGS. 19-20 are illustrations of an intake/output structure showing output buffer ramps, input buffer ramps, and vertical conveyor.

FIG. 21 is an illustration of a carrier showing multiple ways of loading and unloading a tote for intake into or output from the storage system.

FIG. 22 is an illustration of the transfer of a tote from a first carrier to a second carrier.

FIG. 23 is an illustration of the movement of a tote from a row in the storage structure to an output row via a carrier.

FIG. 24 is an illustration of the use of conveyors disposed on the ends of the storage structure for the output of totes from the storage system, wherein carriers are used to transfer the totes from the storage system to the conveyors.

FIG. 25 is an illustration of the use of conveyors for intaking totes into the storage system, wherein the totes are transferred from the conveyor to the storage system via the carrier using a pusher mechanism.

FIGS. 26(A-G) are illustrations of the steps of a process of moving a tote from the conveyor to a carrier utilizing a push mechanism.

FIGS. 27(A-E) are illustrations of the steps of a process of moving a tote from the conveyor to a carrier using a pusher mechanism, wherein the carrier utilizes a stopping plate to stop the motion of the tote along the conveyor.

FIG. 28 is an illustration of the components for utilizing a stopping plate to align the tote with the carrier, wherein the components are attached to and mobile with the carrier.

FIG. 29 is an illustration of a configuration utilizing segmented carriers, wherein the carrier can transfer totes and move between the segments of the conveyor.

FIGS. 30(A-B) are illustrations of carriers which are integrated with the belt portion of the conveyor such as to allow free movement of the carrier along the conveyor and further wherein multiple carriers are utilized on a single conveyor.

FIGS. 31(A-B) and FIG. 32 are illustrations of one embodiment of a retention mechanism.

FIGS. 33(A-F) are illustrations of the operation of a shifting mechanism for shifting a single tote from a first to a second position.

FIG. 34 is a schematic representation of a storage structure having differently sized totes in different layers and varying lengths of totes within the layer.

FIGS. 35(A-B) show various embodiments wherein the layers within the storage structure have varying depths.

FIG. 36 shows an embodiment of the invention showing a storage structure having layers of varying depths, wherein some layers can be serviced by multiple intake/output structure and other layers can only be serviced by a single intake/output structure.

FIG. 37 shows a variation of the invention wherein storage structures are shaped such as to fit the internal structure of buildings in which are deployed.

FIG. 38 shows an embodiment of the invention wherein the storage structure is configured to be deployable around support structures within the building.

FIG. 39 shows a variation of the embodiment of FIG. 38 wherein internal carriers are used to access the ends of non-continuous rows nears support structures.

FIG. 40 is an isolated view of the intake/output structure of the storage structure.

FIG. 41 is a top view of the intake/output structure of the storage structure.

FIGS. 42, 43(A-B), 44(A-B) and 45 are end views of the storage structure showing the relationship between the number of vertical conveyors provided and the number of carriers that can be utilized per layer.

FIG. 46 shows an embodiment wherein different portions of the storage structure are temperature controlled at different temperatures.

FIG. 47 is a schematic of a first embodiment of a vertically configured storage structure using vertical robotic carriers.

FIGS. 48(A,B) is a schematic showing embodiment using automated mobile robots as an intake/output system.4

FIG. 49 is a schematic of a second embodiment of a vertically configured storage structure using vertical platforms.

### DEFINITIONS

As used herein, the term “carrier” refers to a locally or remotely controlled robotic or mechanism capable of moving about a tote support and storage structure in a vertical, horizontal or both directions and capable of accepting, carrying and discharging one or more totes from a source row to a destination row or from an intake of the storage structure or to an output of the storage structure.

As used herein, a “tote” refers to a device capable of carrying goods for transport by a carrier from one location to another. The tote may be configured to be manipulated by a carrier for purposes of movement from a storage location to and from an exit or entry point of the storage system. The tote may be configured as a container or as a flat structure on which other containers may be placed.

As used herein, the term “storage structure” refers to a structure for storing totes and facilitating the placement and retrieval of totes within the storage structure by a carrier.

As used herein, the term “layer” refers to multiple rows for the storage and retrieval of totes. Layers can be oriented in a horizontal, vertical, or any orientation within the storage structure.

As used herein, a “row” is defined as a portion of a storage structure capable of storing a plurality of totes aligned longitudinally with each other and able to move in the longitudinal direction of the row. A row may be horizontal, vertical, or any orientation within the storage structure, but horizontal orientation is the preferred embodiment, because the force to pull a row of totes in the horizontal direction is significantly less than the force needed to lift the coupled totes in vertical direction.

As used herein, the term “constant velocity”, with respect to the movement of rows of totes, is defined as the movement of a row at a substantially constant speed after being accelerated from a stopped position or before being decelerated to a stopped position.

As used herein, the term “conveyer”, is defined as any system capable of moving objects from one place to another, as, for example, using belts, rollers or any other means. A conveyer could operate independently from a mobile carrier or as part of the mobile carrier. A mobile carrier could be considered a conveyer.

### DETAILED DESCRIPTION

The embodiments described herein utilize multiple carriers that work in unison to manipulate totes or other stored product from a storage structure, to efficiently retrieve a particular tote or store a tote. The process utilizes a system of totes or carriers that allow for force to be shared between a row of totes in a singular linear direction (in either positive or negative direction) but also allows for the totes to be decoupled by moving them in a direction orthogonal to the direction of the longitudinal axis of the row (either positive or negative direction). The novel technology can manipulate the totes or other products in both directions to move a target tote (and as a result, all totes coupled to the target tote) toward an end of the row where it may be decoupled from the row.

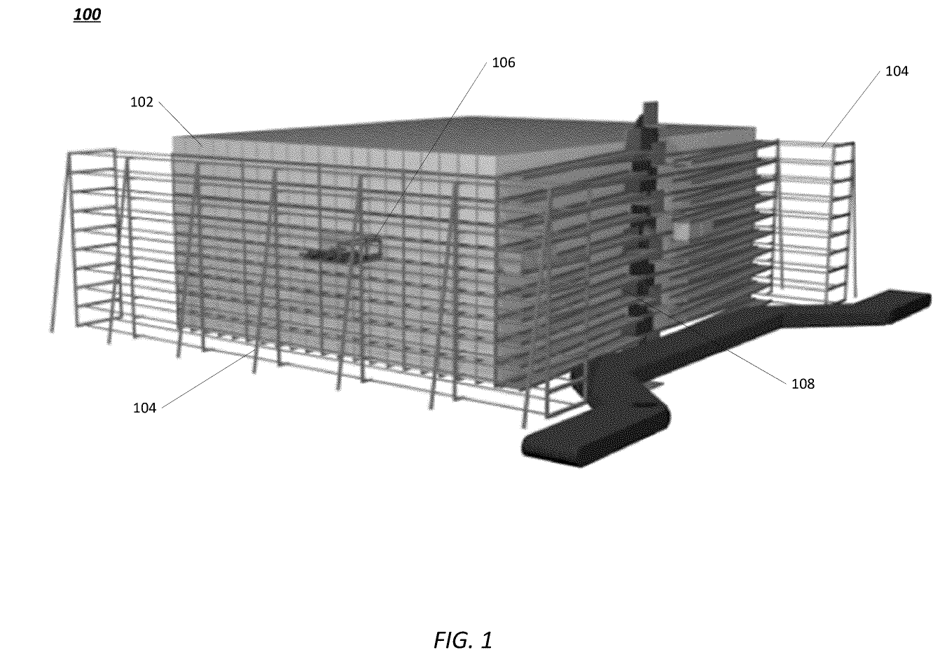

An exemplary storage structure 100 is depicted in FIG. 1. The structure consists of multiple layers of rows 102 containing totes, wherein the totes in each row 102 are coupled to each other to allow movement of the entire row by providing a pushing or pulling force on the tote at the end of the row. Carrier servicing area 104, disposed along opposite sides of the storage structure 100, guide one or more carriers 106 to the ends of rows 102 where the totes are to be manipulated. An intake/output structure 108 may be disposed anywhere within or outside of the structure 100 to facilitate the intake of totes into the system and the output of totes from the system. FIG. 1 shows only one possible embodiment of the system; many variations of the structure and configuration are possible and are considered to be within the scope of the invention.

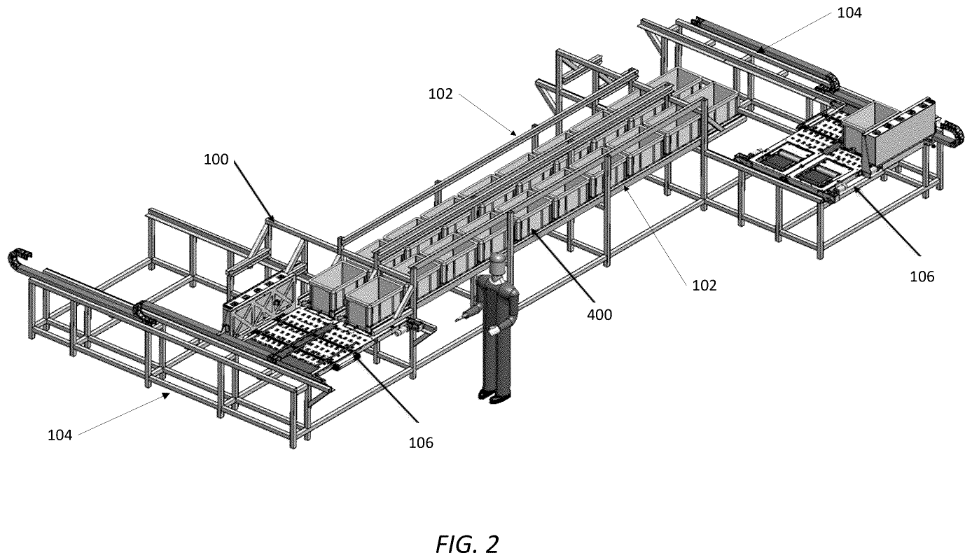

FIG. 2 shows a portion of storage structure 100. The portion shows two rows 102 containing only ten totes 400 per row. However, as would be realized by one of skill in the art, the length of each row 102, and therefore the number of totes 400 that may be stored in a row 102, may be limited only by the ability of the drives to provide the pushing or pulling force necessary to move the entire row of totes, including the weight of the goods contained in each tote. Carriers 106, disposed at either end of the rows 102 may move along carrier servicing area 104 such as to align with rows in the structure 100. Carriers 106 include three types of drive mechanisms which provide the forces necessary to shift totes 400 between rows of storage structure 100. These include the constant velocity drive mechanism 602, the acceleration drive mechanism 604 and the side shift mechanism 606. The various types of drive mechanisms will be discussed in more detail later.

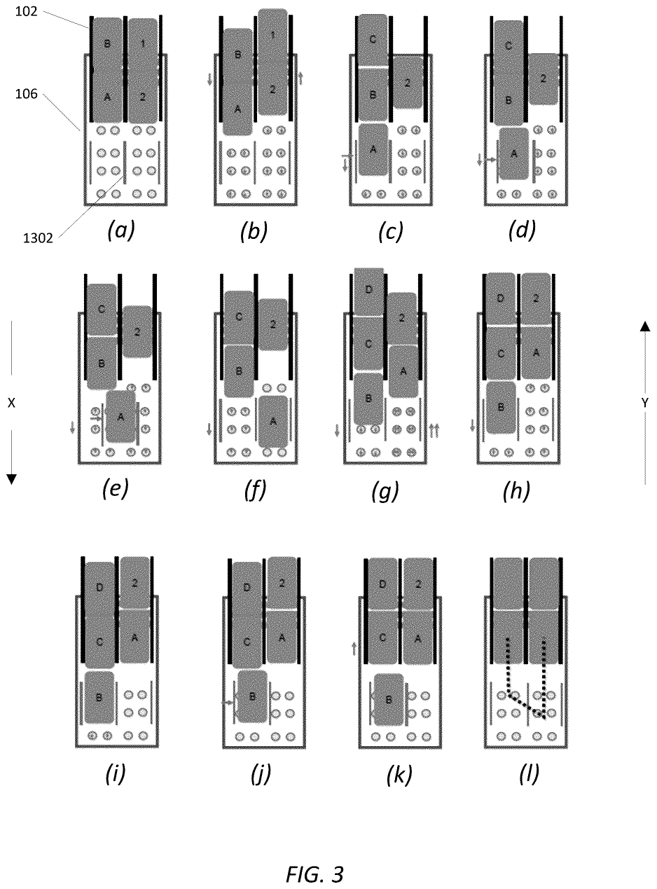

FIGS. 3(a-l) are schematic illustrations of the process by which totes are shifted from one row to another using the pseudo-continuous motion of the present invention. The box labeled 106 in FIG. 3(A) represents carrier 106 in all of FIGS. 3(A-L) and the lines between the totes represent rows 102. The series of illustrations will show the movement of totes labeled “A” and “B” from the left row to the right row. FIG. 3(A) shows carrier 106 in position at the end of two rows of storage structure 102. A constant velocity drive mechanism located in carrier 106 engages tote “A” and as shown in FIG. 3(B), provides a pulling motion which moves the entire left row in direction “X”. At the same time, or at a pre-determined time thereafter, a carrier on the opposite end of the rows 102 engages a tote at the end of the right row and moves the entire right row in direction “Y”. The movement of the left row in direction “X” and the movement of the right row in direction “Y” occur at a constant velocity. FIG. 3(C) shows tote “A” clear of storage structure 102 and completely on the carrier. Once the tote is clear of the storage structure 102 the tote is free to be shifted from one row to another. Totes are shifted from one row to another using a side shift drive mechanism the details of which will be discussed later. In addition, totes can be moved in direction “X” or “Y” while on the carrier via the acceleration drive mechanism, which will also be discussed later. As tote “A” is being pulled from the left row by the constant velocity drive mechanism, the acceleration drive mechanism on both the left side and right side of the carrier matches the speed and direction of the constant velocity drive mechanism. In FIG. 3(D), tote “A” has begun its shift from the left row to the right row. The process of shifting in a direction orthogonal to the row automatically decouples tote “A” from the left row, as will be discussed later. FIG. 3(E) shows tote “A” at the halfway point between the left row and the right row, while still maintaining a constant velocity and direction “X”. In FIG. 3(F), tote “A” is completely aligned with the right row and the acceleration drive mechanism on the right side of carrier 106 reverses direction and accelerates tote “A” in direction “Y” at a faster rate than the constant velocity drive mechanism is pulling the right row in direction “Y”, such that tote “A” catches up with the right row and couples to tote “2”. The actual path of the tote as it moves from the left row to the right row shown in FIG. 3(L). Of particular interest is the diagonal motion of tote “A” as it moves from the left row to the right row on the carrier 106. Also note, as shown in FIG. 3(F), tote “B” is almost out of the left row and positioned on carrier 106. As shown in FIG. 3(G), tote “B” enters the left side of carrier 106 as tote “A” is exiting carrier 106 and being moved into the right row. FIGS. 3(H-K) show the same processes as described above for moving tote “B” into the right row.

Note that once tote “B” is completely aligned with the right row, the constant velocity drive mechanism and acceleration drive mechanism on the left side of the carrier cease movement to avoid pulling tote “C” out of the left row. The pseudo-continuous motion provided by the different types of drives on carrier 106 optimizes the efficiency of the movement of the totes into and out of the rows to provide access to a tote-of-interest located on the interior of the rows in a more efficient manner.

### Tote Configuration

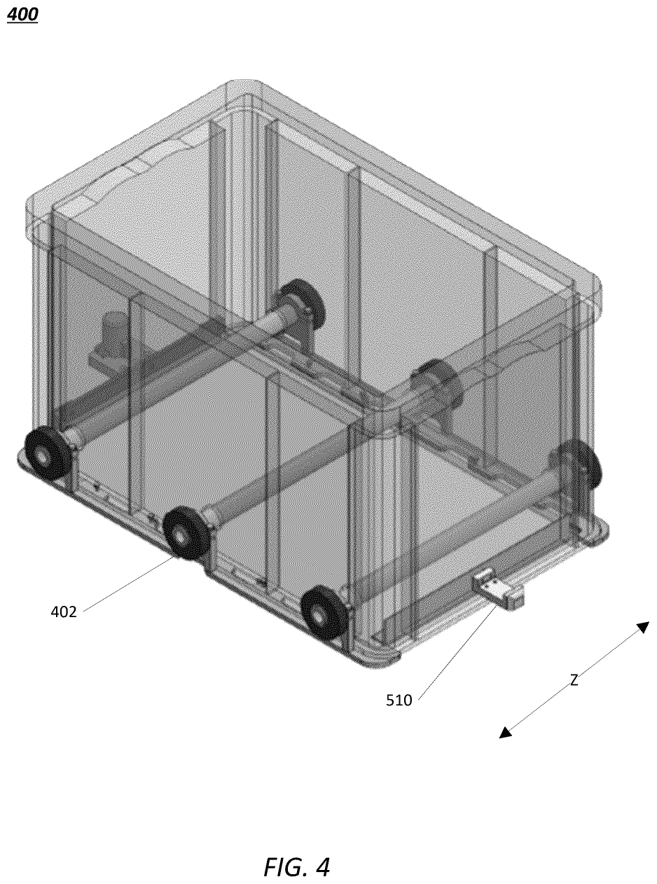

The configuration of totes 400 will now be discussed. A first embodiment of the tote is shown in FIG. 4, wherein the tote embodies a container structure 400 for accepting goods for storage. In an alternate embodiment of the invention, tote 400 may be configured as a flat platform which can accept goods or containers for goods stacked thereon.

As shown in FIG. 4, tote 400 is configured with a series of wheels 402 on opposite sides thereof to allow movement of the tote along a longitudinal axis of each row 102. In one embodiment, shown in FIG. 4, wheels 402 are mounted above the bottom surface of tote 400 and engage parallel tracks disposed on either side of each row 102. In one embodiment, the tracks may be “C-shaped” at support the wheels 402 in both the up and down directions. In another embodiment, not shown, wheels 402 may be disposed near the top surface of tote 400 and would engage the parallel tracks such that tote 400 would hang from the track. In such cases, the tote may be configured as, for example, a flat carrier having a mechanism to engage hanging goods such as clothing. In some embodiments, the wheels may be disposed not on the totes, but in the rows of storage structure 100, wherein the totes ride on the wheel in the rows. IN yet other embodiments, other means may be employed to minimize frictional between the totes and storage structure 100.

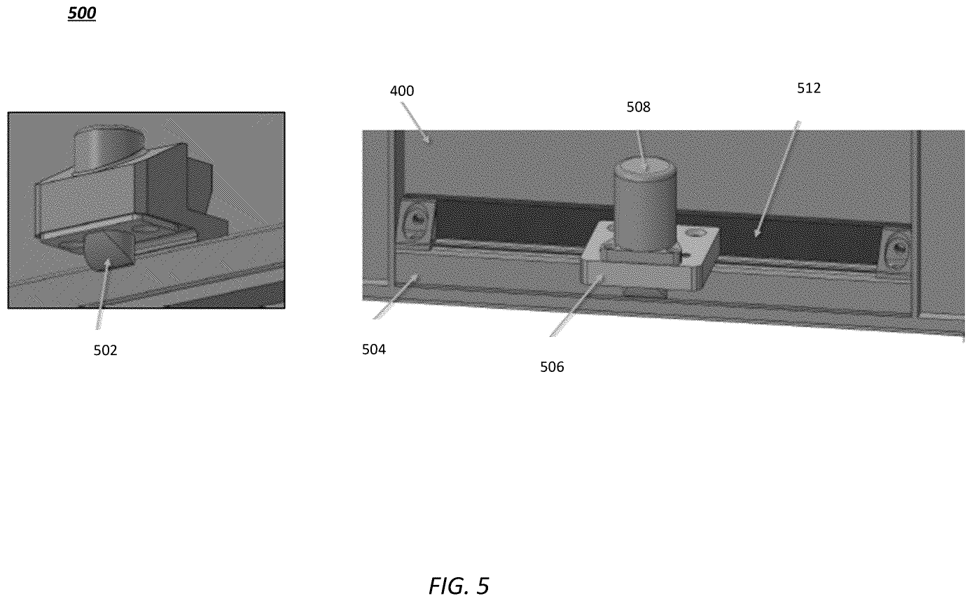

In a second aspect of the invention, totes 400 are configured with a coupling mechanism 500 that automatically engages as totes 400 are moved together. FIG. 5 shows one embodiment of the coupling mechanism. In this embodiment, a first portion of the coupling mechanism 500 comprises a spring-loaded latch 502 having an angled surface that pushes up when the spring-loaded latch 502 encounters a hook mechanism 510, shown in FIG. 4. In one embodiment, coupling mechanism 500 is securely attached to the body of tote 400 via a mounting plate 506 which is securely attached to support structure 504 which in turn is attached to the body of tote 400. Coupling mechanism 500 may include a dust cover 508 and the spacing may be adjusted utilizing a spacer 512 to reinforce the tote wall. In other embodiments of the tote, other configurations are possible. For example, the entire coupling mechanism support structure could be part of the molded plastic from which the tote is constructed.

De-coupling of totes 400 occurs when one tote is moved in a direction orthogonal to the longitudinal line of the row 102, that is, tote 400 is moved towards another row 102 in storage structure 100. As noted in FIG. 4, the edges of hook mechanism 510 are not closed (like the edge portion) such that movement of the tote in either direction indicated by the arrow “Z” will cause hook mechanism 510 to disengage from spring-loaded latch 502, thus decoupling the totes. Thus, as the tote moves from one row to another row, as shown in FIGS. 3(D-E), the tote is automatically decoupled from the adjacent tote in the row. By the time the tote has reached position shown in FIG. 3(E), the tote is completely decoupled from the adjacent tote.

In one alternate embodiment, the totes may be configured with a coupling mechanism 500 and a hook mechanism 510 on each side of the tote, such that the totes may be bidirectionally inserted into and removed from rows 102.

As would be realized by one of skill in the art, the coupling mechanism 500 and hook mechanism 510 just described are only exemplary in nature, and that many other possible mechanisms for coupling and decoupling the totes are contemplated to be within the scope of the invention.

### Carrier Configuration

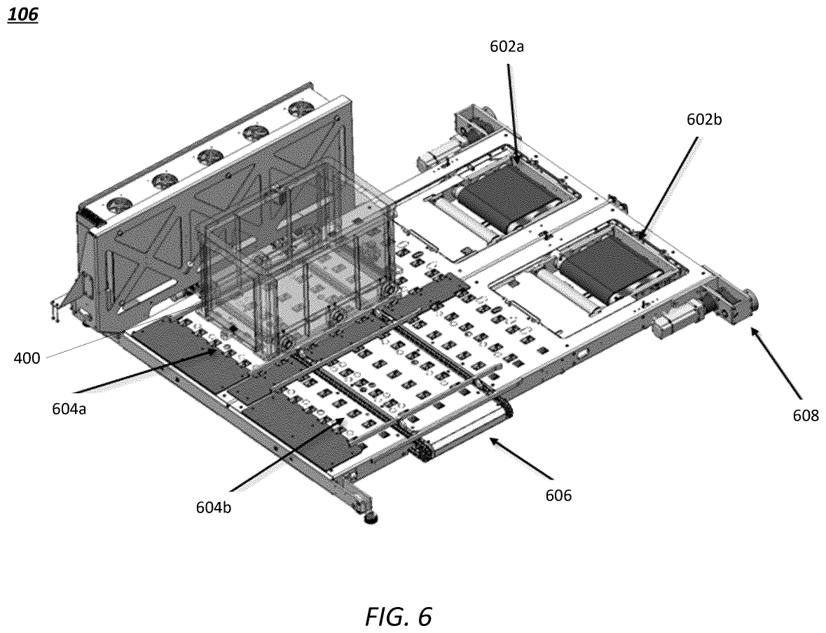

An exemplary configuration of carrier 106 is shown in FIG. 6. In this embodiment, carrier 106 is two rows wide, with one side spaced such as to receive a tote 400 from one row 102 and the other side spaced such as to deposit the tote 400 in an adjacent row 102. In other embodiments of the invention, the carriers may be multiple rows wide, with each row configured as shown in FIG. 6. In an extreme embodiment, carrier 106 may be configured to cover the entire length of the edge of storage structure 100. In yet another embodiment, carriers 106 may be configured to transfer a tote 400 from one carrier 106 to an adjacent carrier 106.

The carrier may be configured with constant velocity drive mechanisms 602a, 602b. Constant velocity drive mechanisms 602a, 602b are bi-directional drives which are configured to engage the end tote in a row 102 such as to pull a series of coupled totes 400 from the row 102 or to push a series of coupled totes 400 into the row 102, depending on the direction of motion of the conveyor belt. In various embodiments, the engagement between the constant velocity drive mechanisms and the totes may be a frictional engagement or may be a positive engagement, for example, with a rack and pinion arrangement. Preferably, constant velocity drive mechanisms 602a, 602b pull the totes 400 from a row 102 or push the totes 400 into row 102 at a constant velocity which is the same for both of constant velocity drive mechanisms 602a, 602b.

Carrier 106 is also configured with acceleration drive mechanisms 604a, 604b, one for each of the rows 102. Acceleration drive mechanisms 604a, 604b are bi-directional drive mechanisms capable of moving totes 400 at a velocity equal to constant velocity drive 602a, 602b, or to accelerate a tote 400 such as to couple it to an adjacent tote 400 that is being moved into a row 102, in which case, the tote must be accelerated to a speed faster than the speed of the constant velocity drive mechanism.

Lastly, carrier 106 is provided with a side shift drive mechanism 606 which is capable of moving totes 400 from one row to another, even as they are being moved in a direction parallel to a longitudinal line of each row 102.

In some embodiments, carrier 106 may be provided with a carrier drive 608 capable of moving carrier 106 within carrier servicing area 104 to align carrier 106 with different rows 102 of storage structure 100. In some aspects of this embodiment, the carrier 106 may be limited to movement within one layer of storage structure 100. In other aspects of this embodiment, the carrier 106 may be configured with a drive mechanism capable of moving carrier 106 between layers of storage structure 100.

Carrier 106 may be provided, in various embodiments, with a plurality of sensors both for providing an identification of a tote 400 via, for example, a barcode mounted on the tote 400, and for sensing the position of a tote 400 on carrier 106.

### Constant Velocity Drive Mechanism

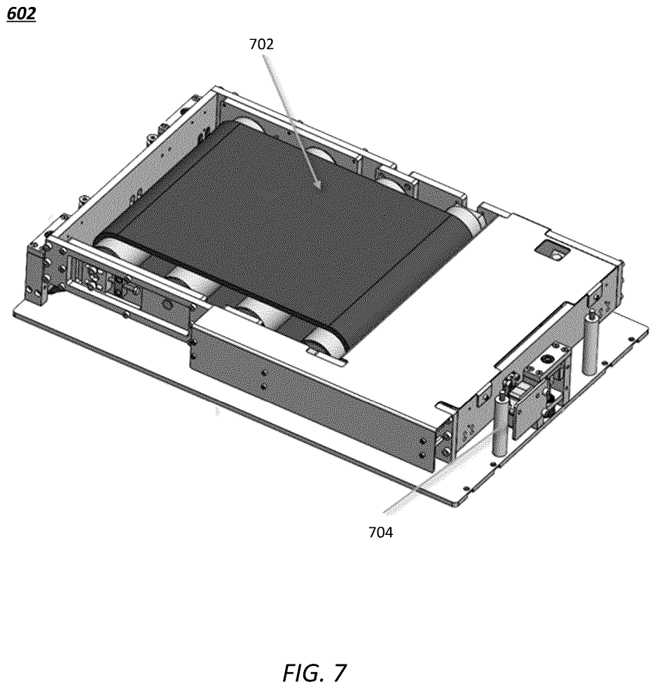

Constant velocity drive mechanism 602, shown in perspective view in FIG. 7 is designed to move totes 400 from a row 102 at a constant velocity onto carrier 106 and to move totes 400 on carrier 106 into a row 102 at a constant velocity. Keeping the row of totes 400 moving at a constant velocity saves energy and time that would otherwise be used in accelerating and decelerating the row as totes are removed from or inserted into a row 102. As such, the source row and a target row are in constant motion until a tote-of-interest is retrieved from the interior of the source row and is positioned on carrier 106.

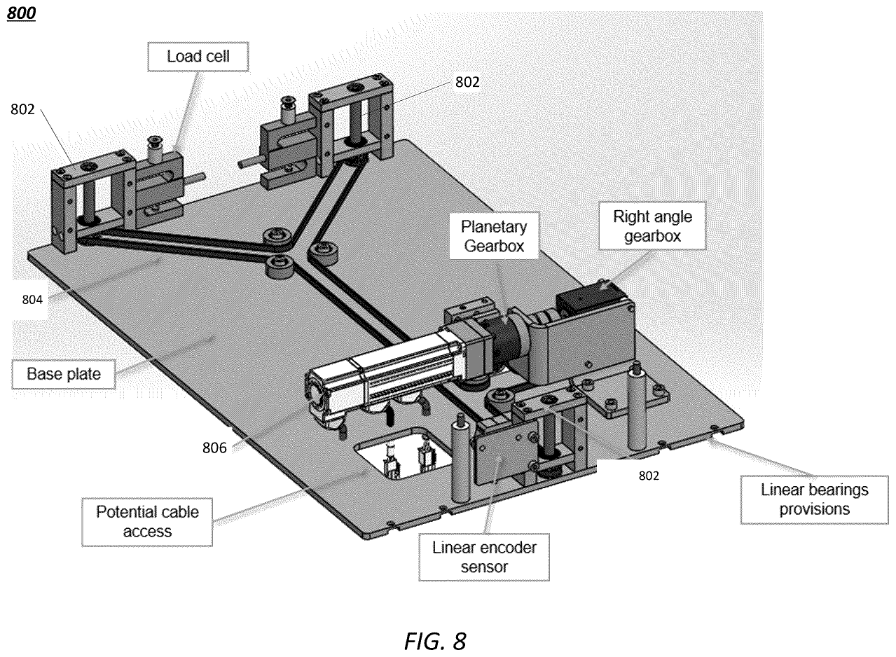

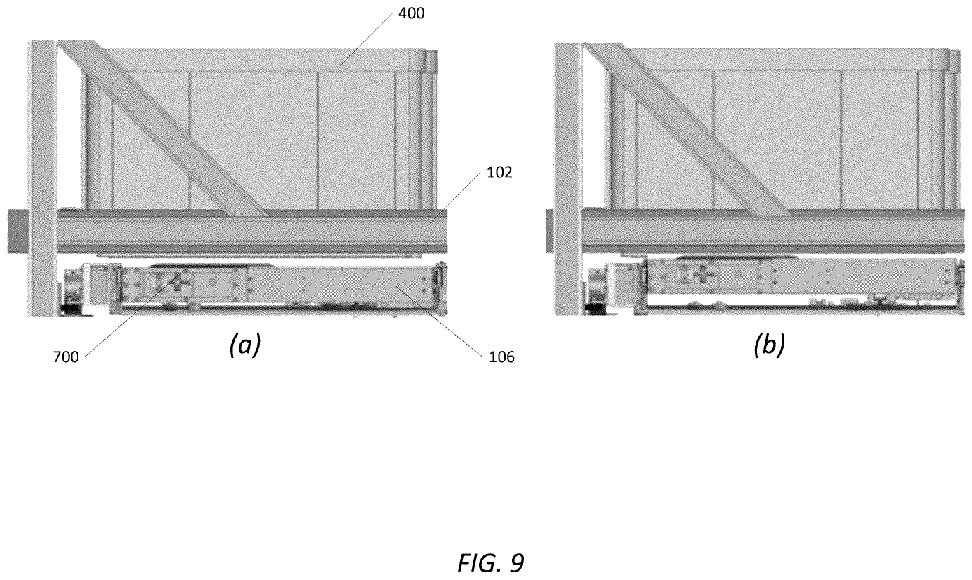

The constant velocity drive mechanism 602 engages a tote by lifting conveyor 702 into frictional contact with the bottom surface of tote 400. Drive mechanism 704 drives conveyor 702 at the constant velocity once the frictional engagement with tote 400 has been made. FIG. 8 shows a lift mechanism 800 for raising the conveyor 702 into frictional contact with the bottom of tote 400. In one embodiment, the lift mechanism 800 consists of three ball screws 802, driven by belt 804. When belt 804 is actuated by motor 806, ball screws 802 are rotated and move upward, thereby lifting conveyor 702 upward and into frictional contact with tote 400. FIG. 9(A) shows the constant velocity drive mechanism 602 disengaged from tote 400, while FIG. 9(B) shows a constant velocity drive mechanism 602 frictionally engaged with tote 400. In various other embodiments, other lift mechanism configurations may be used. For example, a cam-based lifting mechanism could be used. In one embodiment, the entire carrier could act as the lifting mechanism to lift the constant velocity drive mechanism into engagement with the tote. In alternate embodiments, the constant velocity drive mechanism 602 may engage a tote via a mechanical engagement.

It should be noted that rows 102 are cantilevered out from storage structure 100 such that carrier 106 can move underneath the cantilevered portion of each row 102 to engage the tote 400 at the end of the row 102. FIGS. 9(A-B) show carrier 106 with the constant velocity drive mechanism 602 portion of the carrier 106 located underneath the cantilevered portion of rows 102 such that when conveyor 702 is lifted, it frictionally engages the bottom surface of tote 400 at the end of the row.

### Acceleration Drive Mechanism

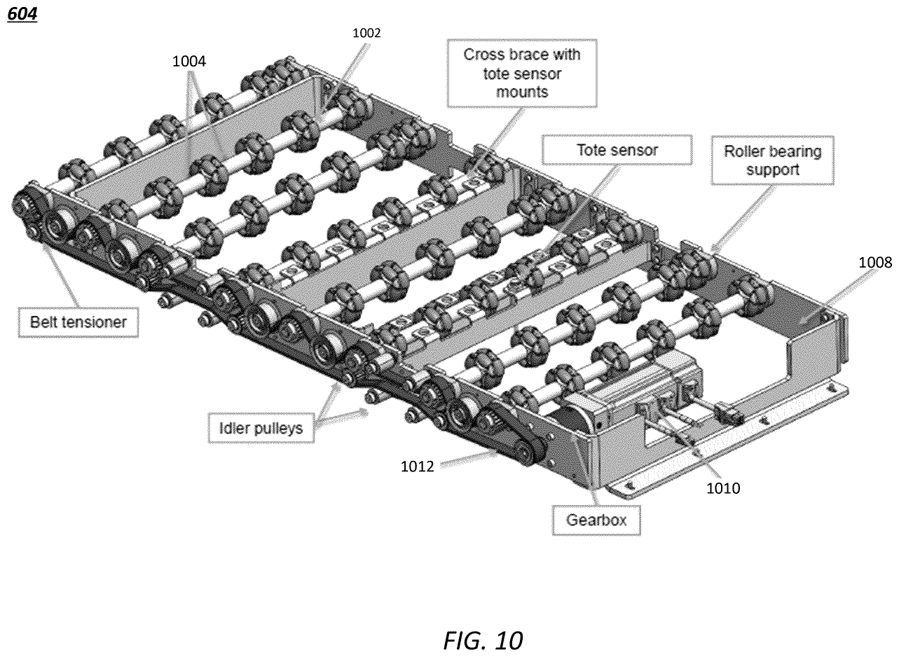

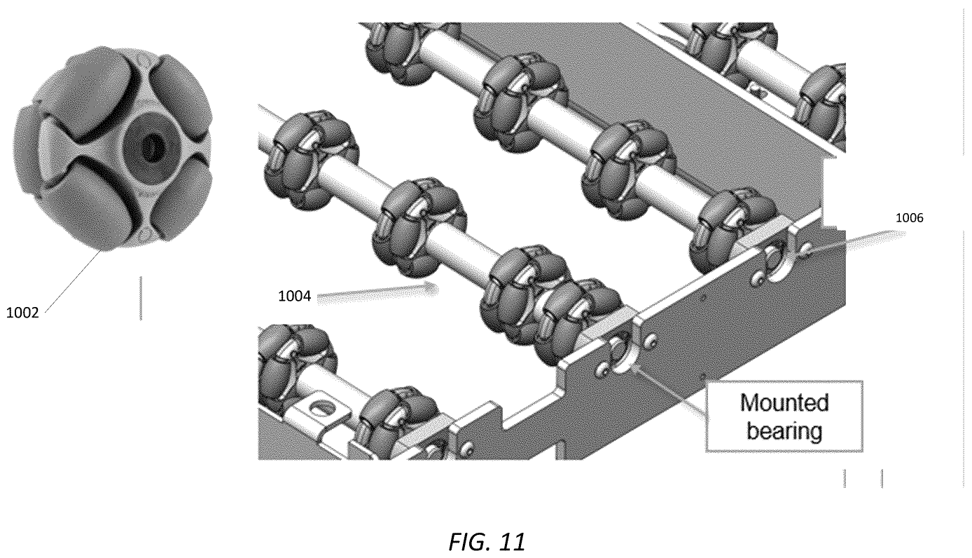

Acceleration drive mechanism 604, shown in FIG. 10 and FIG. 11 consists of a series of Omni casters 1002 mounted in pairs on axles 1006 and separated by spacer tubes 1004. Omni casters 1002 are commercially available off-the-shelf components which, when rotated, engage the bottom surface of tote 400 to move it in the direction parallel to the longitudinal lines of each row 102 of storage structure 100. Axles 1006 are mounted in frame 1008 and driven by motor 1010 via belt 1012. Acceleration Drive mechanism 1000 is bidirectional in that it can accelerate totes 400 in either direction. Omni casters 1002 also allow a near-frictionless side-to-side motion of totes 400 as they are being accelerated away from a source row 102 or towards a target row 102. This allows the tote 400 to follow the diagonal path shown in FIG. 3(L). In one embodiment, omni casters 1002 are provided in pairs such that the tote is always in contact with the portion of an Omni caster 1002 to allow the side-to-side motion.

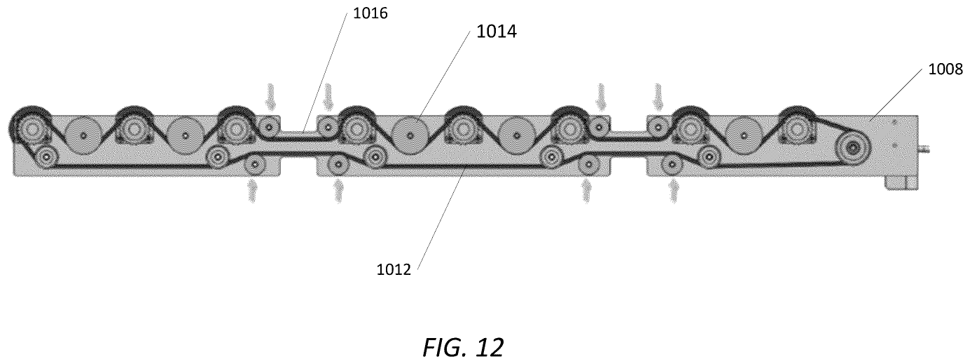

FIG. 12 shows a side view of the acceleration drive mechanism 604 showing belt 1012 disposed around a series of pulleys 1014 to provide the force to rotate axles 1006. Notches 1016 in frame 1008 allow space for the side shift drive mechanism 606, discussed next, to integrate with the acceleration drive mechanism 604.

### Side Shift Drive Mechanism

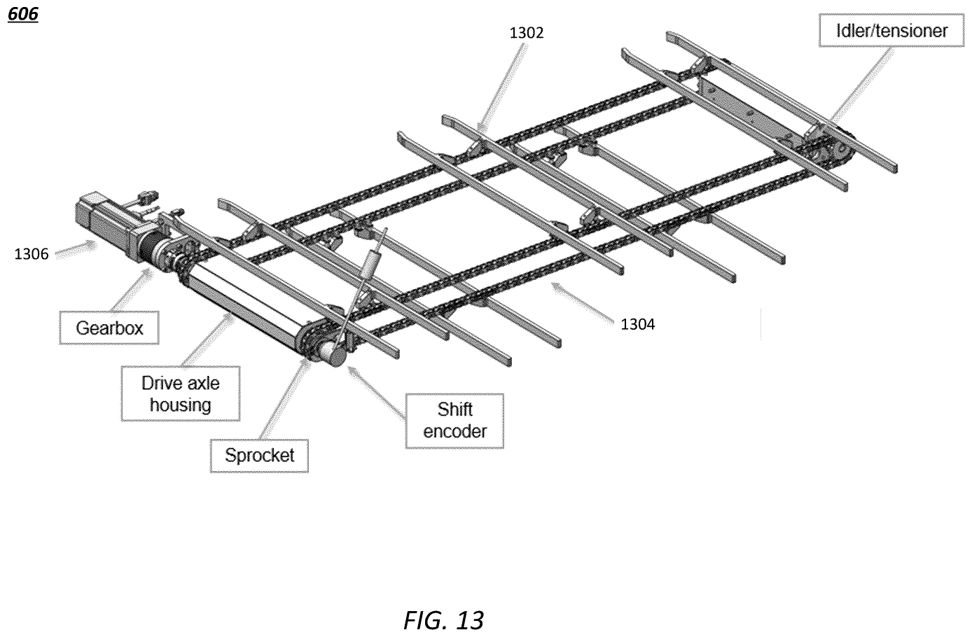

FIG. 13 shows the side shift drive mechanism 606. The purpose of side shift drive mechanism 606 is to push totes 400 from one row on carrier 106 to another row on carrier 106. It should be noted that side shift drive mechanism 606 can be of any length, depending upon the length of carrier 106, and may be capable of shifting totes 400 multiple rows.

Side shift drive mechanism 1300 consists of a set of grousers 1302 driven by a belt or chain 1304. Belt or chain 1304 is driven by motor 1306 via a drive axle. Grousers 1302 move to engage the sides of totes 400 and push the totes 400 in either of the directions indicated by arrow “Z” in FIG. 4. Grousers 1302 are indicated by vertical lines shown in each of FIGS. 3(A-K). Side shift drive mechanism 606 integrates with two or more acceleration drive mechanisms 1000. Chain or belt 1304 fits into slots 1016, shown in FIG. 12.

### Tote Input/Output

In addition to retrieval, storing and shuffling of totes, the storage structure must be capable of outputting a tote from storage structure 100 and intaking a tote into the storage structure 100. In one embodiment, outputting a tote from the storage structure 100 is accomplished by delivering the tote to an output row in the layer of storage system having a downward slope which allows the tote to be gravity fed to either a vertical conveyor located near a pick station of the storage system 100 or to a carrier on a lower level of storage structure 100 which can deliver the tote to the vertical conveyor or, alternatively, to another downward sloped row. In other embodiments, the tote may be output from storage structure 100 by moving it to a level output row having a powered component for moving the tote along the row. Inputting a tote into the storage system is accomplished by delivering the tote via the vertical conveyor to a row in a layer of storage system 100 one layer above the intended target layer and inserting the tote in a row having a downward slope which allows the tote to be gravity fed to the target layer. In certain embodiments of the invention, the gravity feed is accomplished by a row having a slope of approximately 2.5° degrees, however, other degrees of slope may be used.

One possible embodiment of such an intake/output structure is shown in FIG. 1 as reference 108, which shows the intake/output structure located at the end of storage structure 100. As would be realized by one of skill in the art, the intake/output structure 108 could be located at any row 102 within the layer of storage structure 100 and, in fact, the intake/output structure 108 could be located in different rows for different layers of storage structure 100.

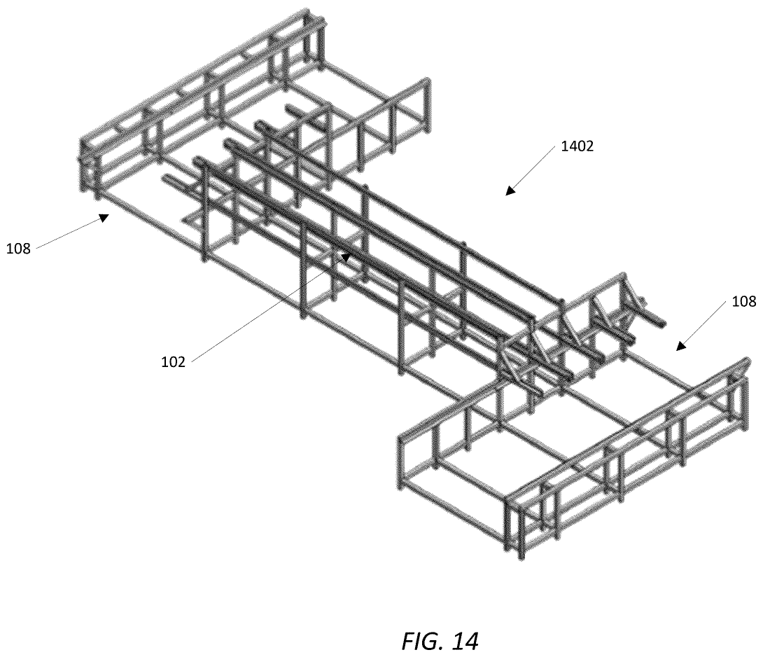

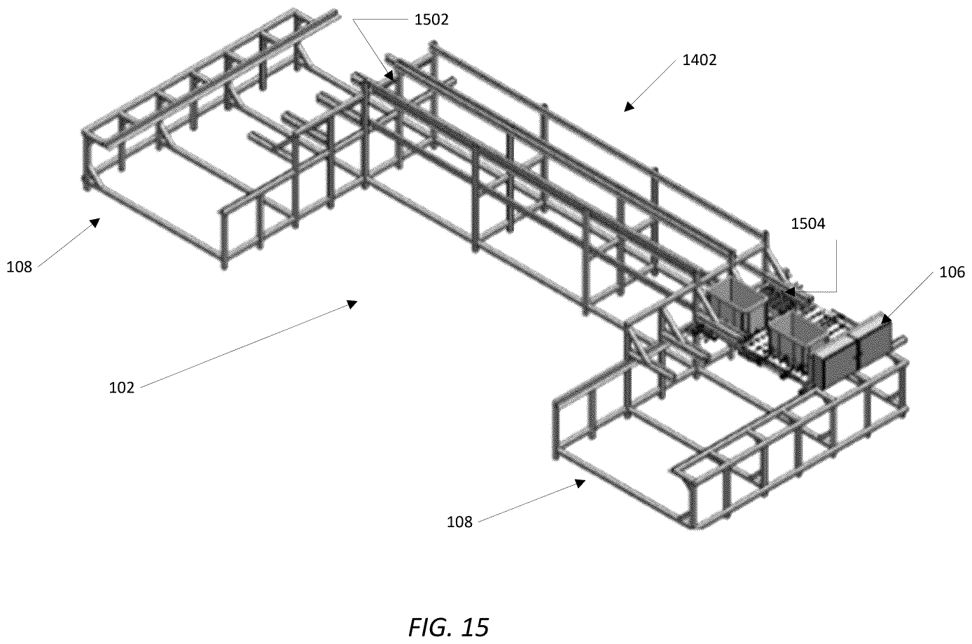

FIG. 14 shows a portion of storage structure 100 having storage rows 102 and carrier servicing areas 108 indicated. The area indicated by reference number 1402 is the area for this layer of the storage system wherein the intake/output structure 108 is to be located. FIG. 15 shows one possible embodiment of intake/output structure 108 for a single row of storage structure 100. Intake/output structure 108 includes row 1502 which allows totes from the next highest layer in the storage structure to be gravity fed to the current layer in the storage structure and row 1504 which allows totes at the current layer is in the storage structure 100 to be gravity fed to the next lowest layer in the storage structure 100. As such, there are two ways to intake and output totes from the storage structure. The first method for outputting totes is a layer-by-layer method in which totes are gravity fed to the next lowest layer and transferred via carrier 106 to another row in the storage structure which in turn gravity feeds the tote to the next lowest layer in the storage structure, until the tote has reached the lowest layer of the storage structure, where it is transferred to a pick station. The second method is by inserting the tote into a row which gravity feeds the tote to a vertical conveyor which then transports the tote to the level of the storage structure and, ultimately, to a pick station.

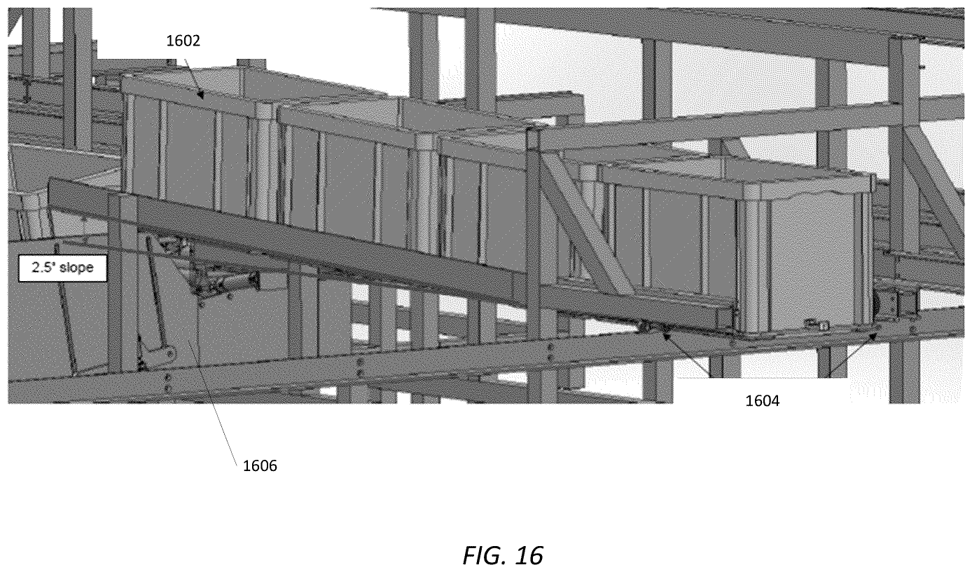

FIG. 16 shows an exemplary intake row of storage structure 100. Totes may be lifted from a pick station by lifting mechanism 1606 to the intake row 1602 and queued within the intake row 1602 until a carrier 106 can load the end tote and transport it to a vertical conveyor, which then lifts the tote to its destination layer (or to a layer above the target layer where the tote is inserted into a downward sloped row to gravity feed the tote to its target layer). It should be noted that while totes are queued in intake row 1602, and because the totes are gravity fed within the row, the end tote must be retained by a retaining mechanism 1604 until a carrier 106 is available to remove the tote from intake row 1602. The retention mechanism 1604 will be discussed later.

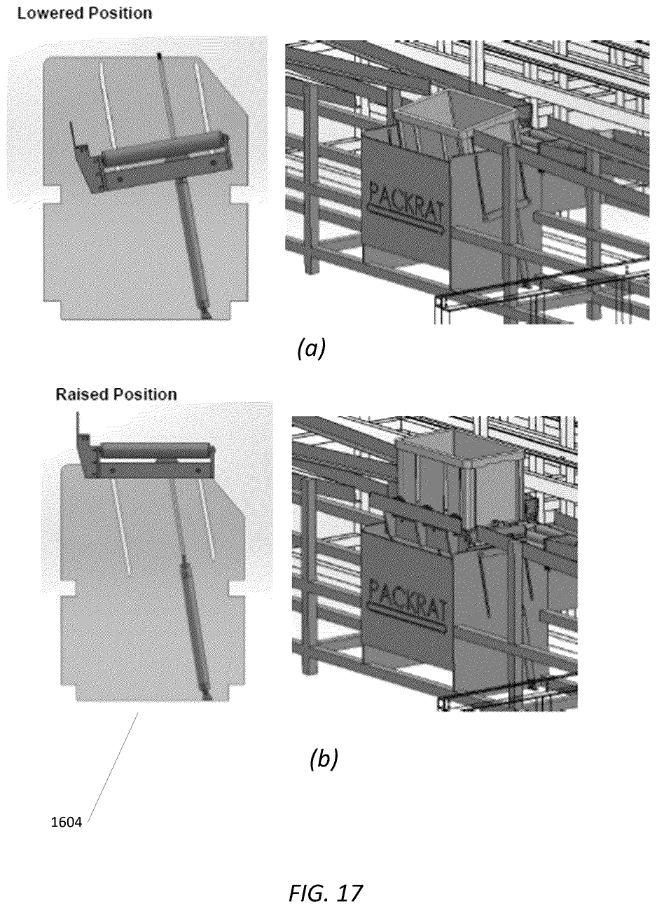

FIGS. 17(A-B) show one possible embodiment of a lifting mechanism 1606 which lifts the tote from a pick station to an intake row 1602 for input to the storage system 100. The tote is placed into the lifting mechanism 1606, which is shown in its lowered position in FIG. 17(A). The tote is then raised, as shown in FIG. 17(B) to a level where it can be pushed into intake row 1602. The lifting mechanism 1606 shown in FIGS. 17(A-B) is exemplary and only and, as would be realized, many other possible configurations of lifting mechanism 1606 are possible without departing from the scope of the invention.

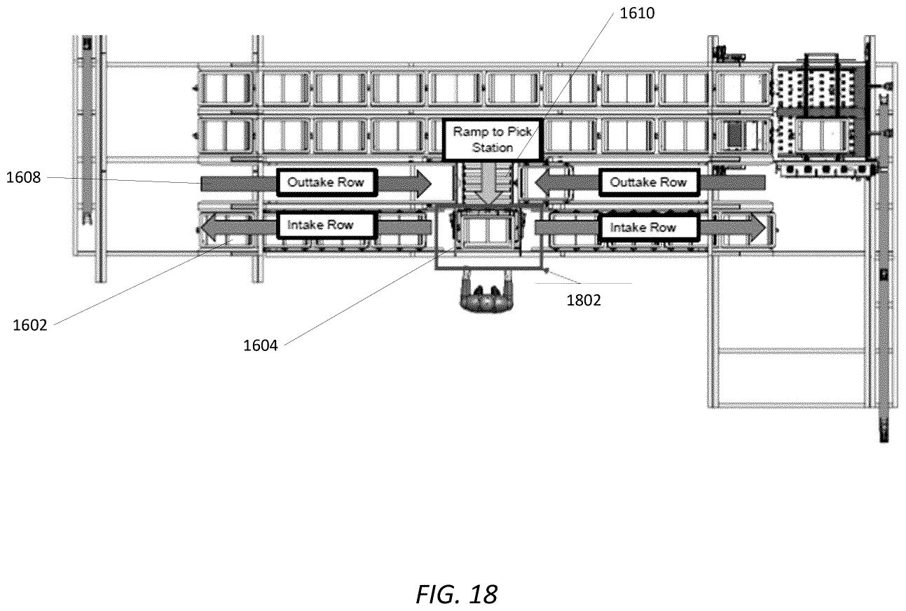

FIG. 18 shows an overhead view of an intake and output row of storage structure 100 at the lowest level with the pick station 1802 is located. To intake a tote in the storage system 100, the worker places the tote in lifting mechanism 1606, which lifts the tote to the level of intake row 1602. Once the tote is queued within intake row 1602, it is gravity fed downward until carrier 106 is available to pick the tote and transport it to vertical conveyor which lifts the tote to the higher layers of the storage system 100.

To output a tote from storage system 100, carrier 106 retrieves the tote either from a downward sloping row within the storage system or from a vertical conveyor and delivers it to output row 1608, where it is gravity fed via a series of rollers 1610 to pick station 1802, where it is retrieved by a worker and removed from storage system 100.

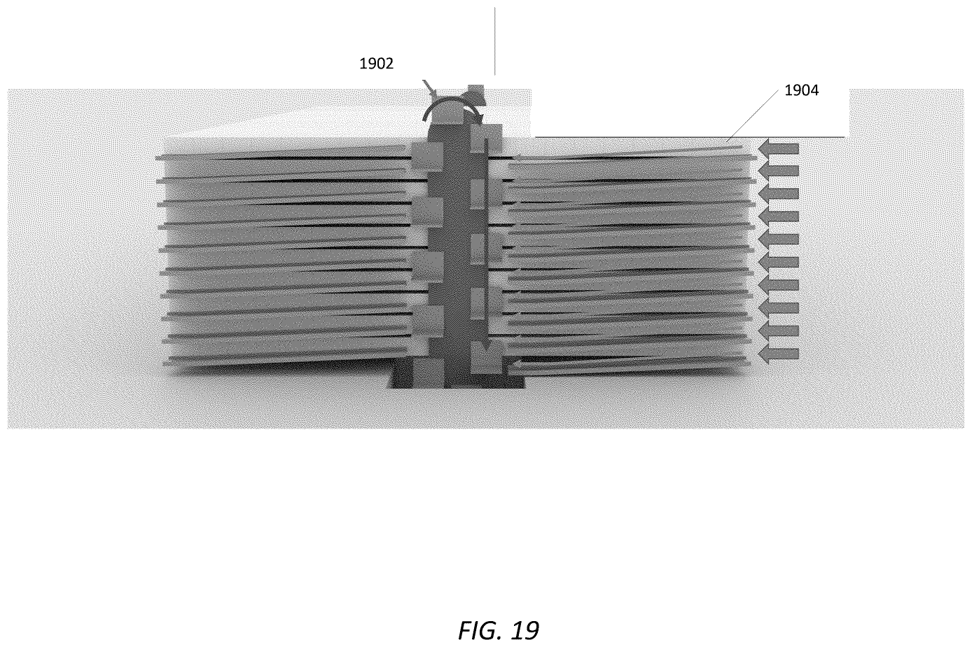

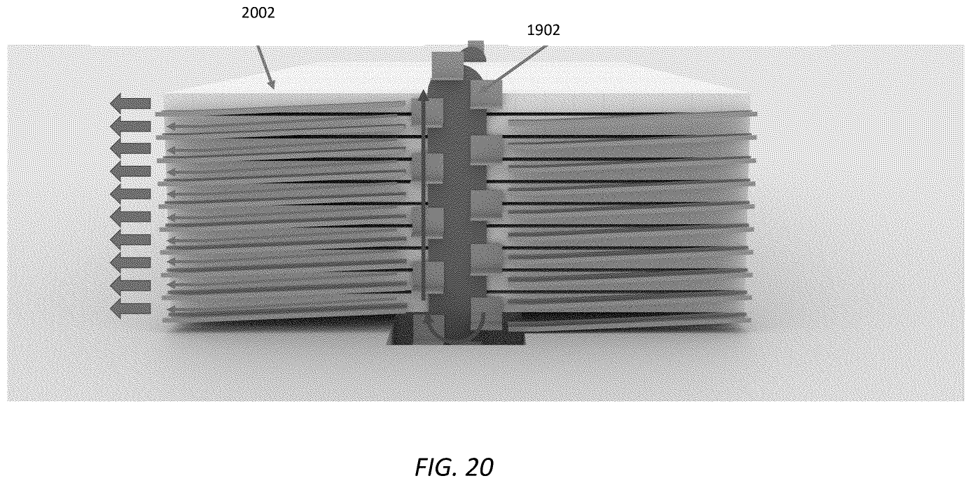

FIGS. 19-20 shows one exemplary embodiment of an intake/output structure 108. In this embodiment, totes are moved vertically via vertical conveyor 1902. When the tote is output from the system, it is placed on the end of one of output buffer ramps 1904 and moves by gravity feed down output buffer ramp 1904, where it is queued until a space on vertical conveyor 1902 becomes available. The totes must be retained at the end of output buffer ramp 1904 until an empty slot on vertical conveyor 1902 can be aligned with the end of output buffer ramp 1904. The vertical conveyor 1902 then moves the tote to the lowest level storage structure 100 where it is conveyed to a pick station 1802.

The input buffer ramp 2002 is shown in FIG. 20. Totes are lifted from the lowest level of storage structure 100 to a level one above the desired target level. The tote is pushed off of conveyor 1902 onto one of input buffer ramps 2002, where it moves by gravity feed down the ramp, where it waits in the queue to be picked up by a carrier 106 and delivered to the target row within the layer. As with the output buffer ramps 1904, when the tote reaches the end of input buffer ramp 2002, a retention mechanism must hold the tote in place until a carrier is available to remove the tote from the bottom of the ramp.

As be realized by skill in the art, the intake/output structure 108 may be located at any position on the end of or within the storage structure 100.

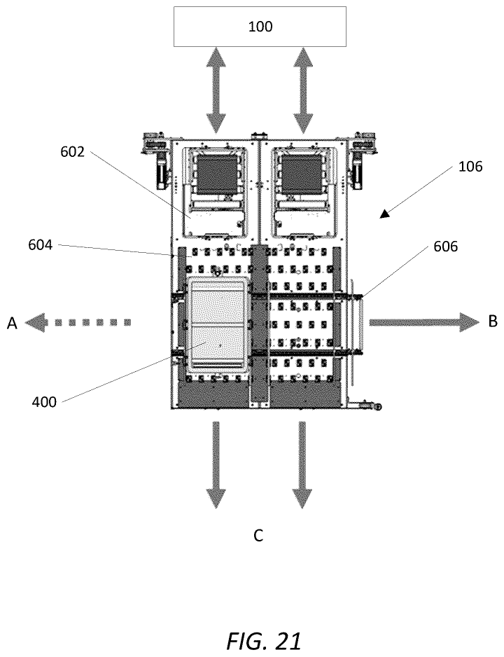

In one embodiment, the output of totes 400 from storage structure 100 may be accomplished by offloading the tote from carrier 106 to an output destination. Such an arrangement is shown in FIG. 21. Carrier 106 can move totes 400 to or from storage structure 100 using constant velocity driver mechanisms 602. Once a tote 400 is fully on carrier 106, instead of moving the tote 400 to another row within storage structure 100, the tote may be offloaded from carrier 106 to, for example, a conveyor belt, another carrier or any other possible destination. Once the tote 400 is fully on carrier 106, it may be offloaded in either of directions “A” or “B” using side shift mechanism 606. Alternatively, tote 400 may be moved in direction “C” from either the left or right rows utilizing acceleration drive mechanism 604.

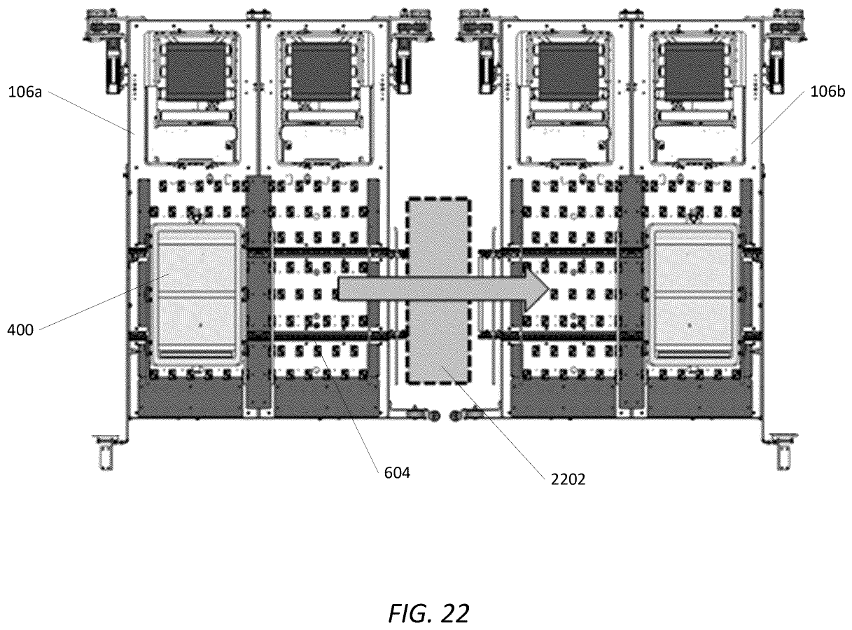

FIG. 22 shows an example of the movement of a tote 400 from a first carrier 106a to a second carrier 106b using side shift mechanism 604. In one embodiment, tote 400 may be required to cross transition area 2202 between carrier 106a and 106b. Transition area 2202 may be, for example, a low friction area, in which case tote 400 may be pushed by side shift mechanism 604 and make cross transition area 2202 by virtue of its own momentum. In other embodiments, transition area 2202 may be provided with a series of Omni casters 1002 to reduce the friction between transition area 2202 and tote 400. In some embodiments, transition area 2202 may be provided with its own side shift mechanism 604. In some embodiments, transition area 2202 may be a part of either of carriers 106a or 106b. In other embodiments, transition area 2202 may be stationary and disposed between the areas of storage structure 100 covered by carriers 106a and 106b respectively. In this case, carriers 106a and 106b may need to move to transition area 2202 to accomplish the transfer. In yet other embodiments, transition area 2202 may be eliminated and carriers 106a, 106b may be able to move close enough to each other to accomplish the transfer. In any case, as tote 400 and moves from first carrier 106a to second carrier 106b, it is desirable that the side shift mechanism 604 both carriers be moving at the same speed.

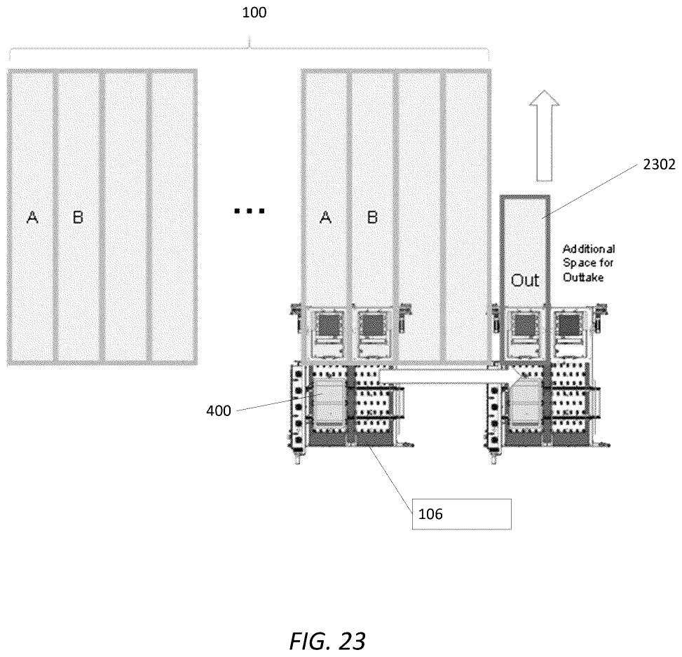

As previously mentioned, a tote 400 may be output from storage system 100 by virtue of a series of downward-sloping ramps. FIG. 23 shows such an arrangement and the delivery of a tote 400 from row “A” in storage structure 100 to output ramp 2302. In this scenario, tote 400 is loaded onto carrier 106 as previously described using constant velocity drive mechanism 602. The tote then moves laterally to downward-sloping output row 2302, where the tote is accelerated toward output row 2302 by acceleration drive mechanism 604 and moved into output row 2302 by constant velocity drive mechanism 602. Once tote 400 has been completely offloaded from carrier 106, it is gravity fed downward row 2302 where it may be retained at the end of row 2302 by a retention mechanism 1604. Once at the end of output row 2302, the tote 400 may be offloaded to, for example, a horizontal or vertical conveyor, as previously described. In various embodiments, either the left row or the right row on carrier 106 may align with output row 2302. In the scenario shown in FIG. 23, tote 400 is loaded from row “A” of storage structure 100 into the left row of carrier 106 and the left row of carrier 106 is aligned with output row 2302. Is also possible that tote 400 could be transferred to the right row of carrier 106, whereupon the right row of carrier 106 would align with output row 2302. This method of outputting totes from storage structure 100 has the advantage of not requiring additional mechanisms (for example, conveyors) to transfer totes laterally.

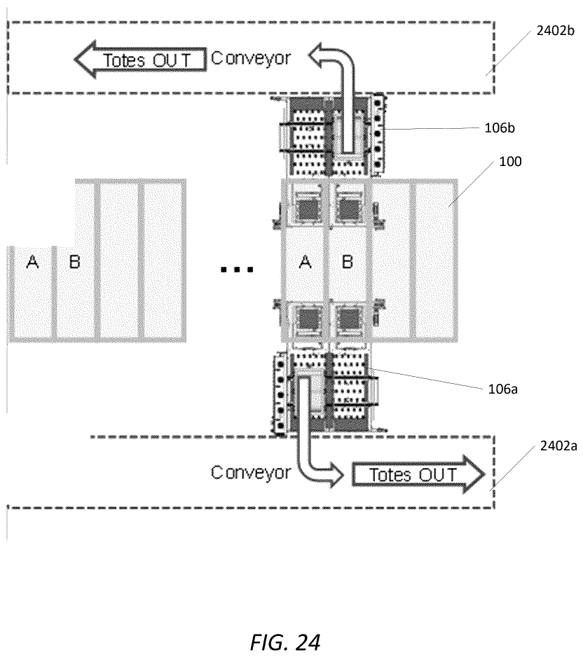

FIG. 24 shows yet another scenario for outputting a tote 400 from storage structure 100. In this case, storage structure 100 is configured with conveyors 2402a, 2402b located on opposite sides thereof. In this case, carrier 106a removes the tote from row “A” of storage structure 100 and delivers it via the scenario described with respect to FIG. 21 to conveyor 2402a. Likewise, carrier 106b may remove a tote from row “B” of storage structure 100 and deliver it to conveyor 2402b. In various embodiments of the invention, storage structure 100 may be provided with conveyors on one or both ends of the rows. In addition, in various embodiments, conveyors 2402a and 2402b may move in opposite directions or may move in the same direction. In yet other embodiments, conveyors 2402a and 2402b may change directions, depending on the situation. Lastly, in various embodiments, it is not necessary that either of carriers 106a or 106b be stationary when transferring tote 400 to the conveyor. The delivery of tote 400 to may occur as carrier 106a, 106b is in motion, for example, in the process of moving to another row within the layer of storage structure 100.

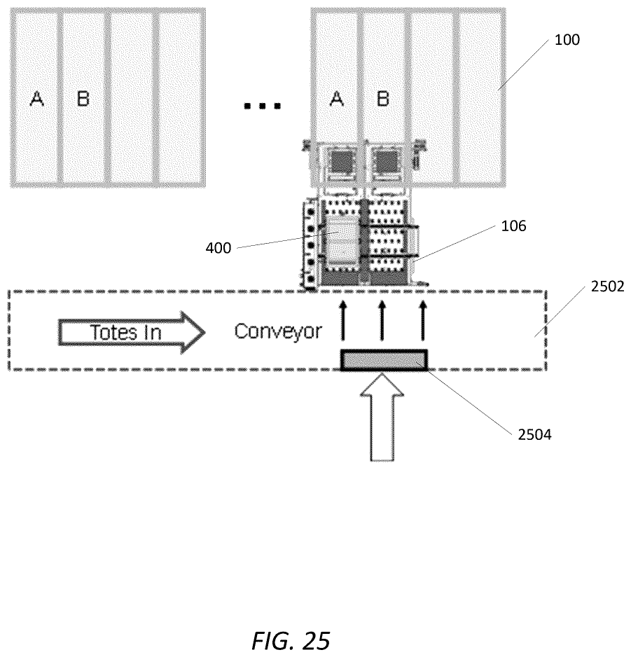

Conveyors located on one or both sides of storage structure 100 may also be used to intake totes into storage structure 100 as shown in FIG. 25. Totes 400 may be fed onto conveyor 2502 by any known means. At any point along conveyor, tote 400 may be pushed onto a carrier 106 by push mechanism 2504. In one embodiment wherein carrier 106 is stationary carrier 106, it would be desirable that the speed of side shift mechanism 606 on tote 106 match the speed of conveyor 2502. In another embodiment, carrier 106 may accept the transfer of tote 400 as it is moving, in which case is desirable to match the speed of conveyor 106 with the speed of conveyor 2502. Once tote 400 has been fully loaded onto carrier 106, carrier 106 may stop at any row within storage structure 100 to insert tote 400 into the row.

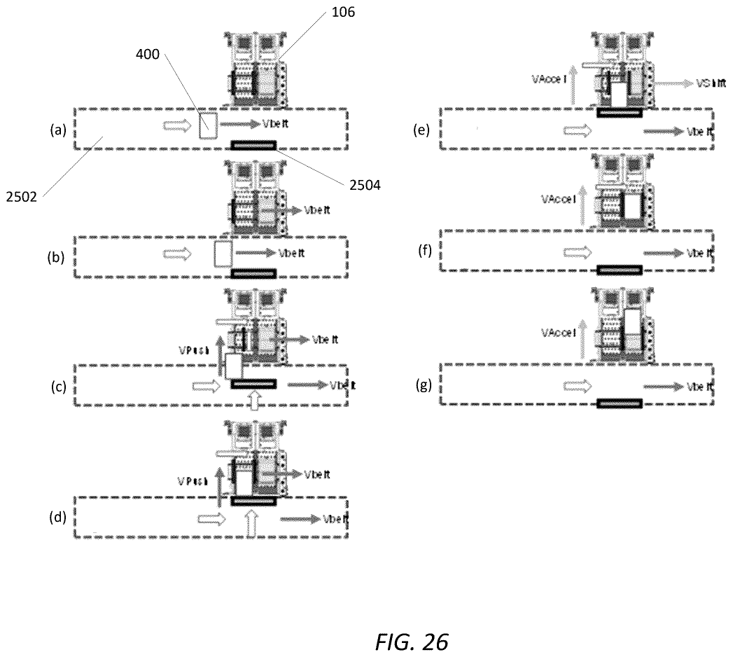

FIG. 26 shows a series of steps for transferring tote 400 from conveyor 2502 to carrier 106. Table 1 below shows the state of each of the components during the process. In step (a), tote 400 is proceeding along conveyor 2502, which is preferably moving at a constant velocity. In step (b), tote 400 is approaching carrier 106 to which it is to be loaded. In preparation for accepting tote 400, the speed of side shift mechanism 606 on carrier 106 is adjusted to match the speed of conveyor 2502. In step (c), pusher 2504 begins to push tote 400 toward carrier 106. Preferably, pusher 2504 begins to push tote 400 such as to align tote 400 between grousers 1302 of side shift mechanism 606. In addition, the speed of acceleration drive mechanisms 604 in both the left and right rows of carrier 106 should match the velocity of pusher 2504. In step (d), tote 400 has been completely loaded onto carrier 106. At this point, pusher 2504 comes to a stop. In step (e), side shift mechanism 606 is moving tote 400 from the left row to the right row of carrier 106 and at the same time the acceleration drive mechanisms 604 in both the left row and the right rows of carrier 106 are moving toward storage structure 100. In step (f), pusher 2504 retracts to the opposite side of conveyor 2502 and tote 400 is fully loaded onto carrier 106. Step (g) shows tote 400 being loaded into storage structure 100 by carrier 106, however, as would be realized, carrier 106 may delay moving tote 400 into storage structure 100 until tote is aligned with the desired destination row.

TABLE 1

| Step | Belt | Pusher | Side Shift | Accelerator |
|---|---|---|---|---|
| A | Constant | Stopped | Stopped | Stopped |
| | Velocity | | | |
| | (V_{Belt}) | | | |
| B | Constant | Stopped | Match | Stopped |
| | Velocity | | Belt | |
| | (V_{Belt}) | | Velocity | |
| C | Constant | Constant | Constant | Match |
| | Velocity | Velocity | Velocity | Pusher |
| | (V_{Belt}) | (V_{Push}) | (V_{Belt}) | Velocity |
| D | Constant | Constant | Constant | Constant |
| | Velocity | Velocity | Velocity | Velocity |
| | (V_{Belt}) | (V_{Push}) | (V_{Belt}) | (V_{Push}) |
| E | Constant | Stopped | Constant | Constant |
| | Velocity | | Velocity | Velocity |
| | (V_{Belt}) | | (V_{Belt}) | (V_{Push}) |
| F | Constant | Retract to | Stopped | Constant |
| | Velocity | Original | (Aligned to | Velocity |
| | (V_{Belt}) | Position | Row) | (V_{Push}) |
| G | Constant | Stopped | Stopped | Constant |
| | Velocity | | (Aligned to | Velocity |
| | (V_{Belt}) | | Row) | (V_{Push}) |

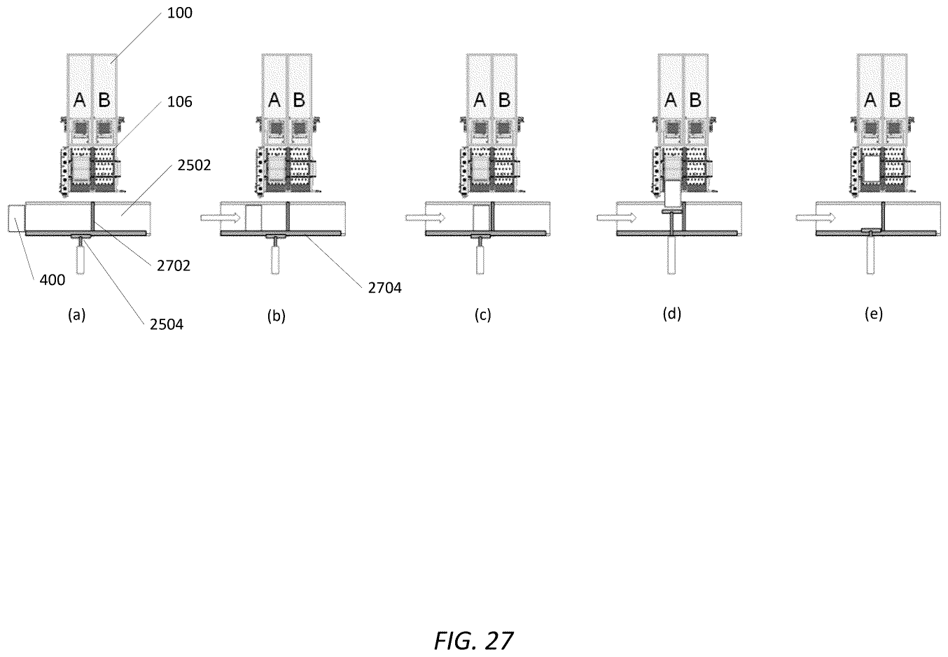

FIGS. 27(A-E) show an alternate embodiment of a method of aligning a tote with a row in carrier 106 such as to be able to push the tote from conveyor 2502 onto carrier 106. In this embodiment, tote 400 is stopped from moving with conveyor 2502 via fixed stopper plate 2702. In various embodiments, a low friction interface between tote 400 and conveyor 2502 may be provided to allow conveyor 2502 to continue its motion even though tote 400 has been stop by stopper plate 2702. Stopper plate 2702 holds tote 400 in alignment with a row (either left or right row) of carrier 106 until pusher 2504 can push tote 400 into the row on the carrier. In other embodiments, conveyor 2502 may stop once tote 400 contacts stopper plate 2702. In FIG. 27(A), tote 400 is loaded onto conveyor 2502 from any source. At FIG. 27(B), conveyor 2502 may be provided with rear backer plate 2704 to maintain alignment of tote 400 as it traverses conveyor 2502. At FIG. 27(C), stopping plate 2702 stops the forward progress of tote 400 and aligns it for loading onto a row of carrier 106. At FIG. 27(D), pusher 2504 pushes tote 400 on to carrier 106 and, at FIG. 27(E) acceleration drive mechanism 604 accelerates tote 400 toward storage structure 100. There are at least three possible embodiments for stopper plate 2702. In a first embodiment, each row of storage structure 100 is provided with a stopper plate 2704 that may be moved into and out of position such as to stop a tote 400 or to allow the tote 400 to pass. In the second embodiment, conveyor 2502 may be provided with one or more stopper plates 2702 that move with the conveyor 2502. In the third embodiment, stopper plate 2702 may be attached to carrier 106 and may move with carrier 106.

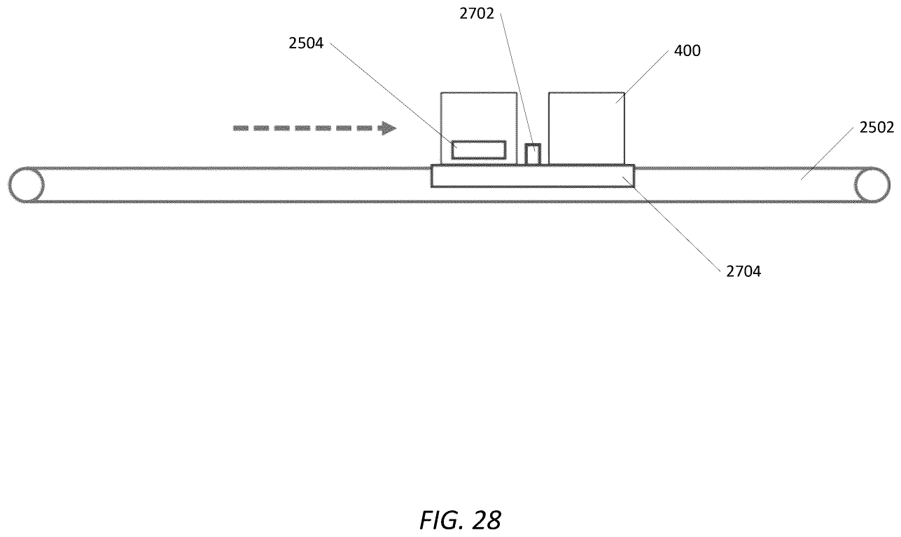

FIG. 28 shows one embodiment of the configuration described with respect to FIGS. 27(A-E) in which the components are attached to carrier 106 and move with the carrier as the carrier moves back and forth with respect to storage structure 100 and conveyor 2502. FIG. 28 shows an embodiment wherein backer plate 2704, stopper plate 2702 and pusher 2504 are connected to carrier 106 via a portion of carrier 106 which extends above conveyor 2502. However, in alternate embodiments, backer plate 2704, stopper plate 2702 and/or pusher 2504 may connected to the carrier 106 via a portion of carrier 106 which extends underneath of conveyor 2502. Also, it should be noted that pusher 2504 is shown on the left row of carrier 106, however, as would be realized by one of skill in the art, multiple pushers may be provided on carrier 106, for example, one for each row of carrier 106, or for selected rows of carrier 106, in the event that carrier 106 is multiple rows in width. As such, with respect to carrier 106 shown in FIG. 28, pusher 2504 could alternatively be located on the right row of carrier 106.

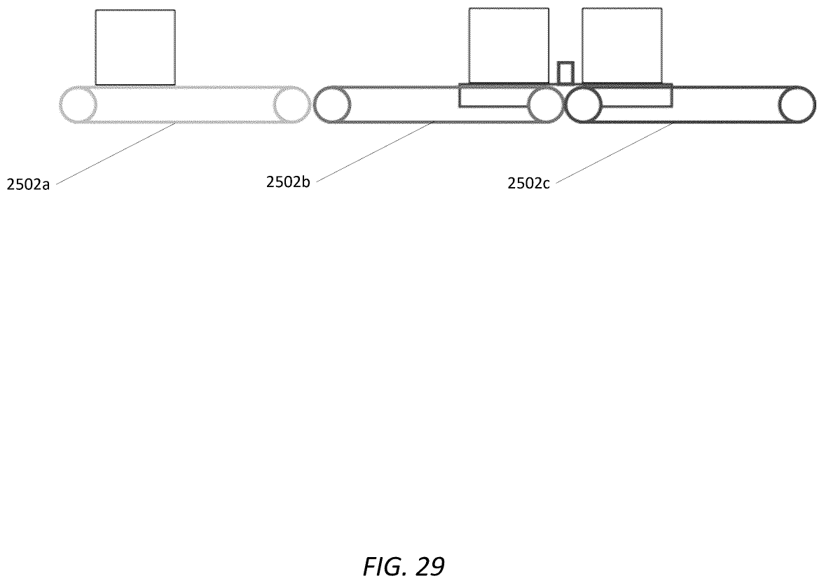

FIG. 29 shows yet another embodiment wherein conveyor belt 2502 may be segmented, for example, in the segments 2502a, 2502b and 2502c. In this case, the embodiment described with respect FIG. 28 wherein backer plate 2704, stopper plate 2702 and pusher 2504 are connected to carrier 106 is able to accommodate the segmented conveyor.

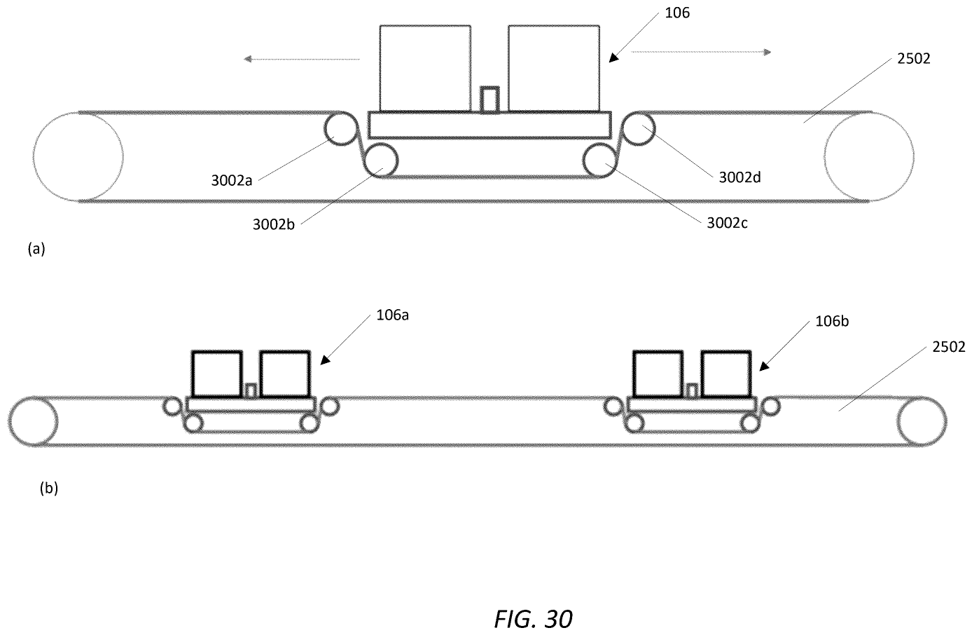

FIG. 30(A) shows yet another embodiment wherein carrier 106 is provided with a series of pulleys 3002(a-d) which engage the belt portion of conveyor 2502 and allow the carrier to move with respect to conveyor 2502 even if conveyor 2502 is in motion in either direction. Preferably the belt portion of conveyor 2502 is aligned with the side shift mechanism 606 of carrier 106, such that the side shift mechanism 606 may be used to move totes 400 from carrier 106 onto conveyor 2502 and from conveyor 2502 onto carrier 106. Therefore, preferably the side shift mechanism 606 of carrier 106 moves at a velocity that matches the velocity of conveyor 2502. FIG. 30(B) shows yet another embodiment wherein multiple carriers 106 may be disposed on the conveyor 2502 to allow for complete freedom of movement of one or more carriers 106 anywhere along the length of conveyor 2502. This config also allows for the ability to shift totes from a first carrier 106a to a second carrier 106b by unloading the tote from carrier 106a, allowing the tote to move to carrier 106b along the conveyor 2502 and then loading the tote onto carrier 106b. As would be realized by one of skill in the art, any number of carriers 106 may be disposed along conveyor 2502 in the configuration shown in FIG. 30(B).

### Tote Retention Mechanism

Anytime a tote is placed on a downward sloping ramp, whether it be an intake ramp or an output ramp, the tote is gravity fed to the bottom of the ramp, where it must be retained until a carrier 106 is available to remove it from the end of the row. As such, a tote retention mechanism 1604 must be provided at the bottom of each sloped ramp. In some embodiments wherein storage structure 100 is not level, retention mechanisms can be added to each row to maintain totes within the storage structure.

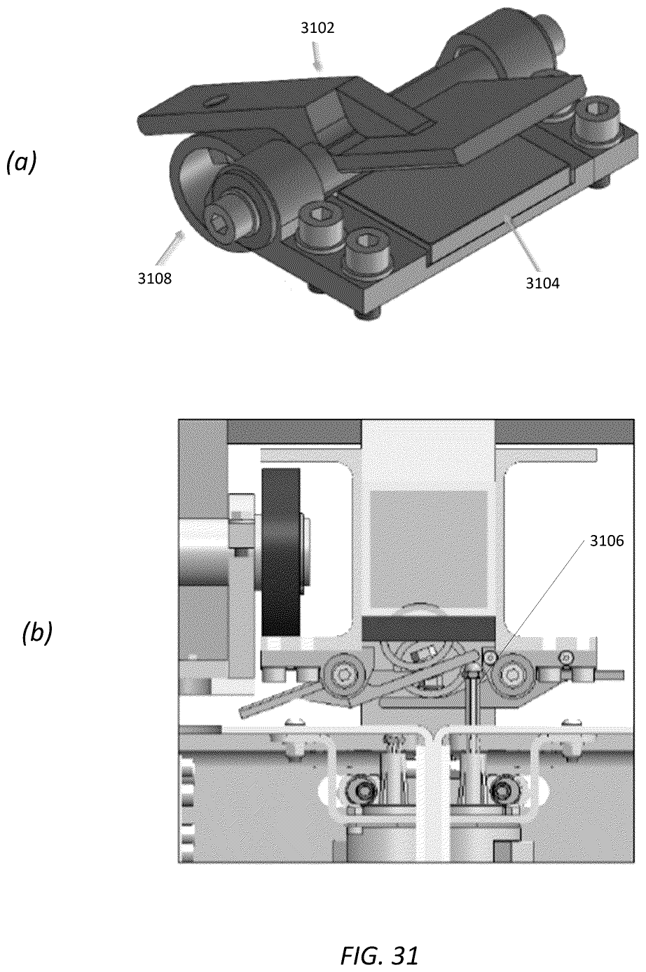

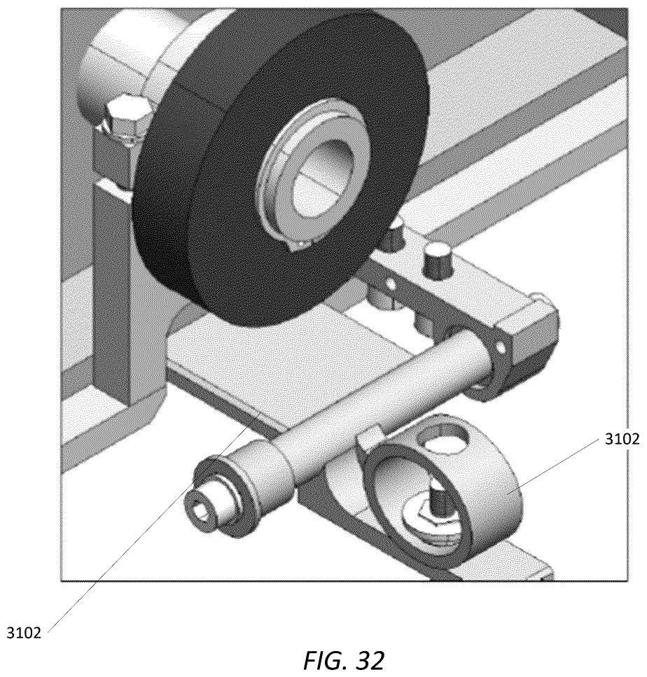

One possible embodiment of the tote retention mechanism 1604 is shown in FIG. 31(A). The retention mechanism 1604 comprises a rotating gate 3102 which pivots to either block the tote from proceeding in a first state or to allow the tote to proceed in a second state. In the first state, wherein the tote is prevented from proceeding, the rotating gate 3102 is held in place by locking magnet 3104. When retention mechanism 1604 switches to the second state to allow the tote to pass, the rotating gate 3102 is nudged from contact with locking magnet 3104 by push mechanism 3106, shown in FIG. 31(B). When the push mechanism 3106 retracts, rotating gate 3102 is again rotated into contact with locking magnet 3104 by spring 3108. Retention mechanism 1604, as shown in FIGS. 31(A-B) is shown in the second state, wherein the tote is allowed to pass. FIG. 31(B) shows mechanism 1604 in situ. As may be realized, a retention mechanism 1604 may be located at both sides of the track, such that both ends of the tote are retained equally to prevent skewing of the tote. Retention mechanism 1604 is shown in its first state in FIG. 32 where the rotating gate 3102 is engaged with the bottom of the tote to prevent movement of the tote off of the sloped ramp.

### Shifting Mechanism

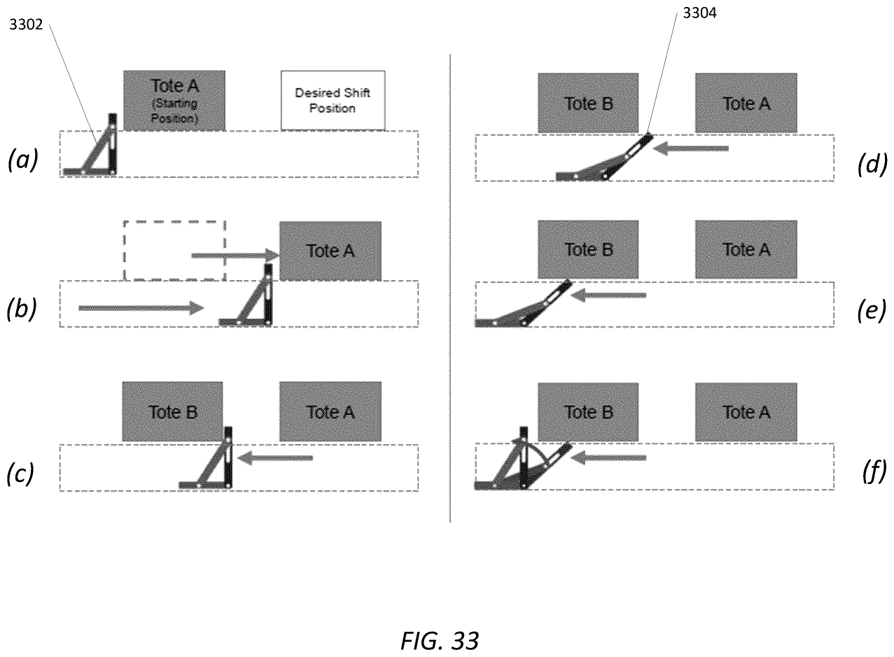

It may, at times, be necessary to shift tote from a first position to a second position, for example, when shifting a tote from the pick station lift mechanism 1606 to the input ramp. FIGS. 33(A-F) show a spring-loaded push mechanism 3302 for accomplishing the shifting of a tote. FIG. 33(A), shows tote “A” in a first position, the desired position and push mechanism 3302. In FIG. 33(B), push mechanism 3302 has pushed tote “A” to the desired position. FIG. 33(C) shows that tote “B” has replaced tote “A” and it is now desired to push tote “B” into the position now occupied by tote “A”. Push mechanism 3302 moves backward and, as it contacts tote “B”, as shown in FIGS. 33(D-E), the spring-loaded head 3304 of push mechanism 3302 bends forward to allow clearance around tote “B”. As shown in FIG. 33(F), as push mechanism 3302 reaches the end of tote “B”, the spring-loaded head 2304 springs back up and pushing mechanism 3302 is now ready to push tote “B” into the desired position. As would be realized by one of skill in the art, many other variations of push mechanism 3302 may be possible and are contemplated to be within the scope of the invention.

### Storage System Configurations

The invention has been described in terms of a carrier 106 having a particular configuration, namely, two rows wide with two constant velocity drive mechanisms 602, two acceleration drive mechanisms 604, and a single side shift drive mechanism 606. In addition, carrier 106 is mobile, allowing movement from row to row within the layer. However, many other configurations are possible.

In one embodiment, carrier 106 may be more than two rows wide. In such a configuration, carrier 106 would be equipped with a constant velocity drive mechanism 602 for each row and an acceleration drive mechanism 604 for each row, in addition to a single side shift drive mechanism 606. In this configuration, carrier 106 would be mobile.

In one embodiment, each layer of storage structure 100 may be zoned, wherein each zone is serviced by a non-mobile carrier 106 and wherein each carrier 106 is as wide as the zone that it services and is equipped with a constant velocity drive mechanism 602 for each row, an acceleration drive mechanism 604 for each row, and a single side shift drive mechanism 606. In this case it is necessary for carrier 106 to be able to move totes to an adjacent carrier 106.

In one embodiment of the invention, each layer of storage structure 100 may be provided with a single non-mobile carrier which is as wide as the layer of the storage structure 100. In this embodiment, each carrier 106 is equipped with a single constant velocity drive mechanism 602 for each row, a single acceleration drive mechanism 604 for each row, and a single side shift drive mechanism 606.

As be realized by one of skill in the art, carriers 106 are disposed on opposite ends of storage structure 100. In various embodiments, each side of the storage structure 100 may be configured differently in accordance with one of the embodiments of carriers noted above.

In one embodiment, the storage structure 100 may be provided with an intake/output structure on one or both ends thereof, as shown in FIG. 1.

In one embodiment of the invention, the storage structure 100 may be provided with an intake/output structure that comprises sloped ramps located on any row of each layer.

In one embodiment of the invention, the storage structure 100 may be provided with an intake/output structure that comprises sloped ramps located in different rows of each layer.

In one embodiment, the storage structure 100 may be provided with internal, sloped ramps at the lowest level that transport totes from the sloped ramps to a pick station.

In one embodiment, the storage structure 100 may be provided with one or more vertical conveyors 1902 for moving totes vertically within the storage structure 100.

The invention has been described in the context of specific embodiments, which are intended only as exemplars of the invention. As would be realized, many variations of the described embodiments are possible. For example, variations in the design, shape, size, location, function and operation of various components, including both software and hardware components, would still be considered to be within the scope of the invention, which is defined by the following claims.

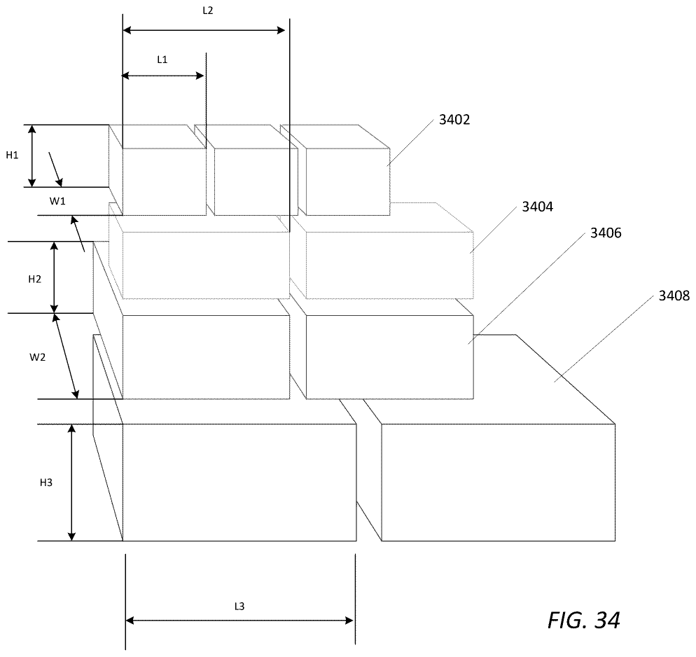

The various embodiments of storage structure 100 previously discussed are all homogeneous in nature. That is, each row has the same number of totes per row. However, in variations of those embodiments, it is possible the storage structure 100 will be non-homogeneous, having totes that vary in size. FIG. 34 shows several exemplary configurations for the totes. The totes in layer 3402 are shown as having dimensions of length L₁, height H₁ and width W₁, while, for example, the totes in row 3404 have dimensions of L₂, height H₂ and width W₂. Likewise, the totes in rows 3406 and 3408 have varying dimensions. The sizes of totes can be varied within storage structure 100 as long as certain criteria are met. For example, because each layer of storage structure 100 is serviced by pairs of robotic carriers 106 that move horizontally within the layer, each tote within the layer must have the same width and a maximum height. However, the lengths of the totes may vary from row to row within the layer or within a single row of the layer. The length of the totes is limited only by the length of the carriers 106 which are servicing that particular layer. In various embodiments, various layers of storage structure 100 may house totes of different widths. In certain embodiments, carriers 106 have the ability to move between layers of storage structure 100. In such a case, the robotic carriers may have the ability to adjust for different widths of the totes. In addition, the intake/output portion of storage structure 100 needs to be able to handle totes of various sizes.

In non-homogeneous embodiments, carriers 106 are aware of the lengths of the totes. There are two ways by which carriers 106 become aware of the size of the next tote in the row. The first is because the storage system 100 as a whole is a deterministic system. That is, the system is aware of all totes within the system, the sizes of the totes and the positions of each tote within storage structure 100 (as well as what good are stored within each tote). In addition, each tote may be provided with a barcode that either directly specifies the size of the tote or provides a reference number that can be looked up in a database to obtain information about the tote. In certain embodiments, the barcode may be used to verify the system's knowledge of each tote within storage structure 100.

### Variations on the Storage Structure Configuration

The storage structure 100 may be adapted in various ways to accommodate limitations imposed on the structure due to the environment in which she structure is deployed. For example, the building in which storage structure 100 is deployed may be irregular in shape or may have support columns that interfere with storage structure 100. Because it is desirable to use as much of the space of a building as possible to maximize the capacity of storage system 100, storage system 100 may be adapted in various ways to adjust to the structure of the building. The next few embodiments discuss ways in which storage structure 100 can be configured such as to adapt to various environments.

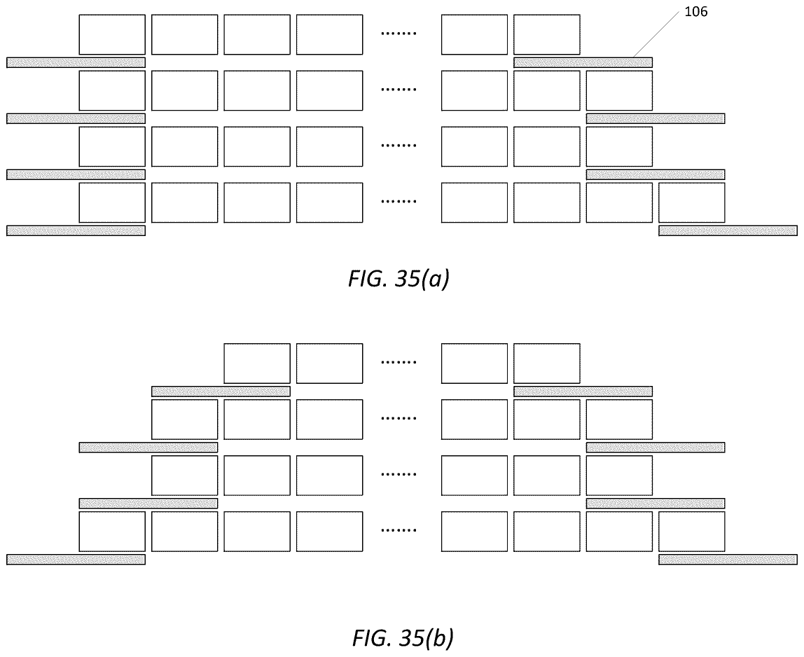

In various embodiments, the length of the rows may vary from layer-to-layer. FIGS. 35(A-B) show side views of two possible embodiments of storage structure 100 showing variation in the length of the rows. FIG. 35(A) shows a first embodiment wherein all layers within storage structure 100 are aligned on one end and have varying depths such as to be uneven on the other end. FIG. 35(B) shows a second embodiment wherein neither ends of the layers are aligned. Note that is not necessary that layers having a smaller depth be placed on top of layers having a larger depth. It is possible that the structure could be inverted such that layers lower in the structure have a smaller depth and layers higher in the structure have a larger depth or, layers could vary in depth without regard to their vertical position within the structure.

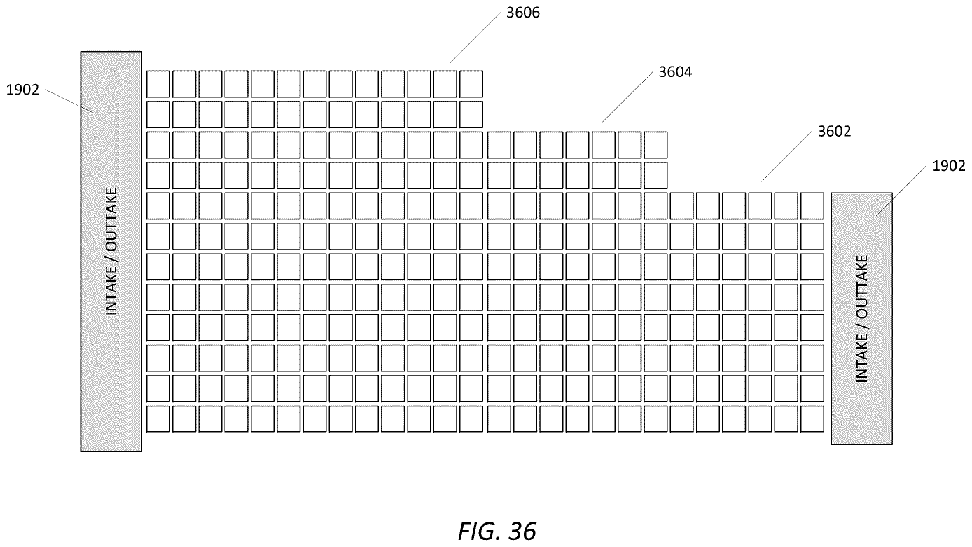

FIG. 36 shows yet another embodiment of a configuration of storage structure 100 wherein the view is looking into the ends of the rows. In this embodiment, the number of rows per layer is varied from layer-to-layer. It should be noted that, in this embodiment, the rows in area 3602 have access to vertical conveyor 1902 on both sides thereof, while the rows in areas 3604 and 3606 have access only to the vertical conveyor 1902 on the left side of the structure. This gives rise to a storage strategy in which more frequently accessed goods are stored within totes in area 3602 such as that their retrieval is more efficient due to the access to multiple vertical conveyors 1902. It should further be noted that the rows in area 3602 may be configured with multiple pairs of carriers 106 per layer, while the layers in areas 3604 and 3606 may be restricted to having one pair of carriers 106 per layer, unless the carriers 106 are provided with the capability of conducting carrier-to-carrier transfers. Lastly, because the retrieval strategy requires circular motion of the totes between multiple rows, a layer must comprise a minimum of two rows.

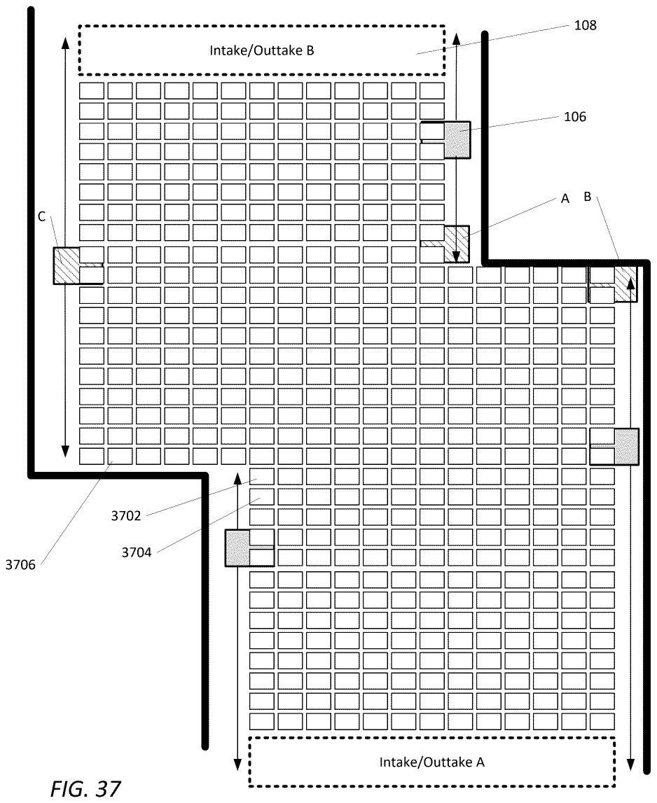

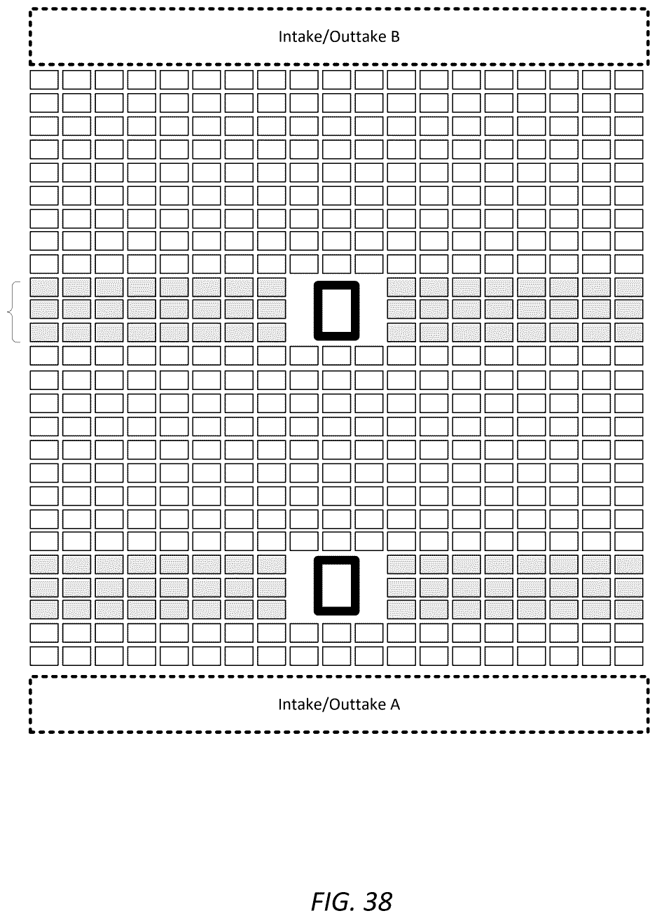

FIG. 37 shows a top view of yet another variation in the embodiment of storage structure 100. In this embodiment, rows in a single layer may be offset from each other to accommodate variations in building shape. In this embodiment, because the shape of storage structure 100 may restrict the movement of carriers 106 within a layer, to maximize the circular motion used during the retrieval of totes, it may be necessary to restrict the rows from which totes may be retrieved and stored. For example, to remove the tote from the interior of row 3702, it is possible to remove totes from row 3702 and place them in row 3704 (or any other row of similar length) but it may not be possible to remove totes from row 3702 and place them in row 3706 because the carrier 106 servicing the left end of row 3702 is unable to access the left end of row 3706. The only way to transfer totes from row 3702 to row 3706 using two carriers 106 would be if gaps exist in row 3706 such that insertion of a tote in the right end of row 3706 does not result in a tote moving out of the left end of row 3706. Alternatively, three carriers 106 (“A”, “B” and “C”), could be used to transfer totes between offset rows when positioned, for example, as shown in FIG. 37 to set up a “serpentine” motion of totes. This type of motion is described, for example, in currently-pending PCT application PCT/US20/67174, the contents of which are incorporated herein in its entirety. FIG. 38 shows a top view of a configuration of storage system 100 which is adapted to fit around structural columns contained within the building. In one embodiment of the structure having non-continuous rows, the interior of the rows nearest the support columns may not be supported by carriers 106. As such, it is possible to store totes in area 3802 of the structure as long as there are no gaps between totes within the row. For example, totes may be inserted into a row and empty spaces may exist nearest the support column, however, all totes within these rows must be coupled to each other. Note that it is also possible to shift totes from a non-continuous row to a continuous row within the structure.

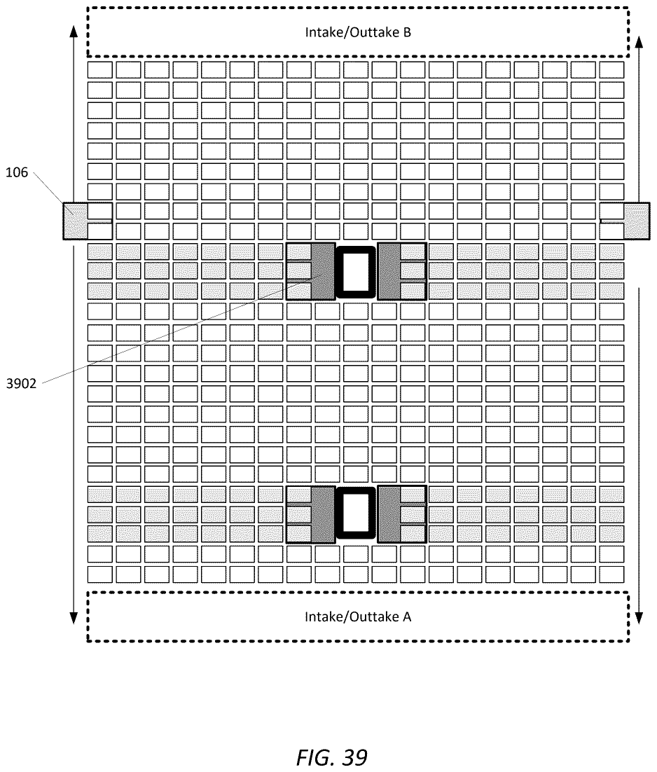

FIG. 39 shows a top view of an alternate configuration of storage system 100 which is adapted to fit around structural columns. In this case, the interior ends of the non-continuous rows are configured with a fixed carrier 3902 which enables the circular motion within the non-continuous rows when paired with mobile carriers 106 on the exterior of the non-continuous rows. In this case, the fixed carriers 3902 shown in FIG. 39 are constructed to be 3 columns wide. Alternatively, in the event that a large block of non-continuous rows exists, the interior ends of the rows may be fixed with a mobile carrier 106 identical to carriers 106 on the outside of the storage structure. In certain embodiments when fixed carriers 3902 are used, it may be necessary to configure the non-continuous rows such that they may be easily removed from storage structure 100 to provide a way to maintain and service the fixed carriers 3902.

### Intake/Output Structure Configurations

It is desirable to minimize the overall footprint of the storage structure 100 and to make the most efficient use of the available space for the storage of totes. Therefore, in some embodiments, a system for queuing and picking of totes is provided which conforms to the overall footprint of the storage structure 100 and which is disposed on the bottom layer thereof.

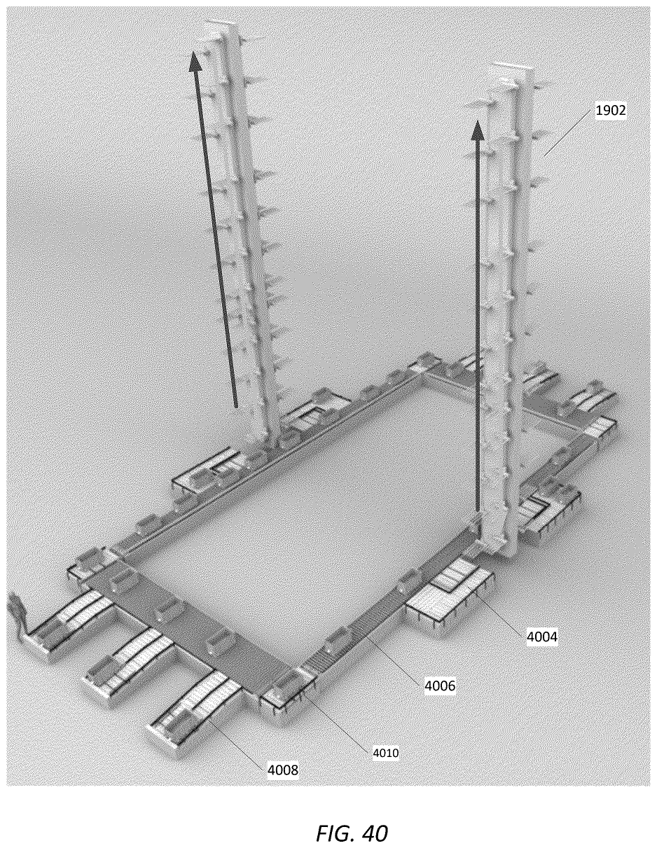

FIG. 40 shows an isolated view of a novel intake/output structure 108 of the present invention. In this embodiment, vertical conveyors 1902 move totes from the various layers of storage structure 100 to the lowest layer, which is used to support queueing and picking of the totes. Tote transfer conveyors 4004 move totes from the vertical conveyors 1902 to a circuit conveyor 4006. In the exemplary embodiment shown, circuit conveyor 4006 is shown in a rectangular configuration, however, as would be realized by one of skill in the art, any configuration of circuit conveyor 4006 may be used to conform to the footprint of storage system 100 in accordance with the variations previously described herein.

In preferred embodiments, the totes move around circuit conveyor 4006 in a singular direction (i.e., either “clockwise” or “counter-clockwise”) and the totes are preferably maintained in a particular orientation on circuit conveyor 4006. At various points along circuit conveyor 4006 are arranged one or more pick stations 4008.

Totes may be pushed from circuit conveyor 4006 to any one of pick stations 4008. Goods may be removed from the tote at pick station 4008, after which the tote is returned to circuit conveyor 4006 and, eventually, back into storage structure 100. Alternatively, tote may be removed from the storage system 100 at any one of pick stations 4008. Empty or partially full totes may also be delivered to a pick station 4008 at which time they may be filled with goods and returned to storage structure 100 for restocking purposes. In some embodiments, totes containing goods may be automatically offloaded from a mobile storage structure contained in a mobile container, such as a truck, which can interface with the stationary storage structure when parked at a loading dock.

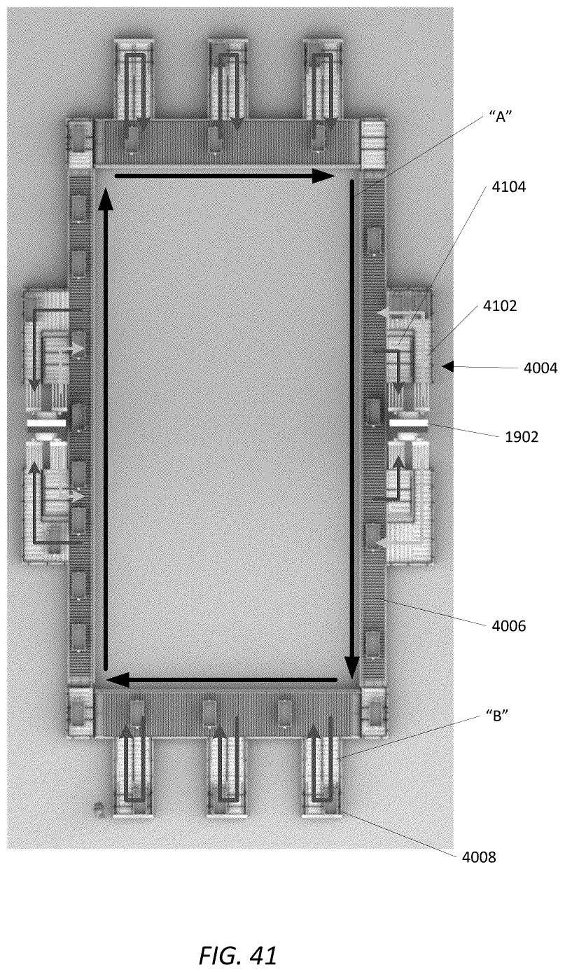

FIG. 41 shows a top view of intake/output structure 108. Transfer conveyors 4004 serve two purposes. First, transfer conveyor 4004 has a first portion 4102 that serves to move totes which have been removed from vertical conveyor 4002 on to circuit conveyor 4006. Second, transfer conveyor 4004 has a second portion 4104 that moves totes from circuit conveyor 4006 onto vertical conveyor 4002 to return the totes to the storage structure. In one embodiment, the movement of totes on transfer conveyor 4004 may be accomplished via drive mechanisms of the type used on carriers 106, namely, acceleration drive mechanism 604 and shift drive mechanism 606. Other types of drive mechanisms capable of shifting the totes in the desired directions may also be used.

Once on the circuit conveyor 4006, in preferred embodiments, totes move in a single direction “A” as indicated by the arrows. Totes could also move just as easily in the opposite direction, as long as the direction of movement is consistent throughout the circuit conveyor 4006, regardless of the shape. Also, in preferred embodiments, it is desirable to maintain the orientation of the totes. Therefore, when totes reach a corner, directional transfer conveyors 4010 serve to shift the tote from one portion of circuit conveyor 4006 moving in one direction to a second portion of circuit conveyor 4006 moving in a second, orthogonal direction, without rotating the tote or otherwise changing its orientation. As with transfer conveyors 4004, directional transfer conveyors 4010 may be equipped with one or more drive mechanisms of the type used on the carriers 106, for example, acceleration drive mechanism 604 and shift drive mechanism 606. Other types of drive mechanisms may also be used to change the direction of the tote, as long as the orientation of the tote is not changed. It should be noted that any number of direction transfer conveyors 4010 may be used, depending on the footprint of storage structure 100 and the number of direction changes required to move the tote in a complete circuit around intake/output mechanism 108.

One or more pick stations are disposed at any point along intake/output structure 108. As would be realized, the purpose of the pick station is to allow for the retrieval and storage of goods within storage structure 100. In operation, a tote is pushed from circuit conveyor 4006 onto a pick station 4008 on one side as shown by arrows “B”. Once the tote reaches the bottom of pick station 4008 a human may remove a good from a tote, add a good to a tote or remove the tote from storage structure 100. Totes may also be manually added to storage structure 100 by placing them at the bottom of any pick station 4008. Once human interaction with the tote is complete, the tote is moved in the direction of arrow “B” back onto circuit conveyor 4006 and, ultimately, back into storage structure 100. In some embodiments, a pick station 4008 may be provided with a means for human to provide a signal to the system to indicate that the interaction with the tote is complete and the tote may be moved back onto continuous carrier 4006. Pick stations 4008 may be equipped with one or more drive mechanisms of the type used on the carriers 106, for example, acceleration drive mechanism 604 and shift drive mechanism 606, to affect the motion of totes to and from circuit conveyor 4006. Other types of drive mechanisms may also be used. Storage structure 100 may be configured with any number of pick stations 4008.

Circuit conveyor 4006 also serves two purposes. First, the totes are moved around the circuit of the intakes/output mechanism 108, preferably in a single direction. Second, the totes, when aligned with, for example, a transfer conveyor 4004 or pick station 4008, will be pushed off of circuit carrier 4006. This may be accomplished by any one of a number of means, for example, a shoe-type sorter may be used. In some embodiments, circuit conveyor 4006 may be temporarily stopped when totes are aligned with their destination on transfer conveyor 4004 or pick station 4008 until the tote has been pushed off of circuit conveyor 4006.

In some embodiments, totes may make one or more circuits around intake/output structure 108. For example, if orders are coming to the top of an order queue to be picked, and an order further down in the queue requires a product that is currently in a tote on circuit conveyor 4006, the tote may be retained on circuit conveyor 4006 until required for the second order. In some embodiments, the goods within the tote may be required at more than one pick station 4008, in which case the totes may move along circuit conveyor 4006 from one pick station to another. In some embodiments, a tote may be retained on circuit conveyor 4006 and to provide a queuing function such as to hold the tote within the intake/output structure 108 until it is needed on a pick station 4008 to build an order. In some embodiments, a pick station 4008 requiring a particular tote may be full, in which case, the tote may be retained on circuit conveyor 4006 for multiple circuits until a spot on pick station 4008 becomes available.

It should be noted that intake/output structure 108 may be equipped with any number of vertical conveyors 1902. In certain embodiments, certain optimizations may be provided by a control system to determine which vertical conveyor 4002 to use to provide the most efficient route to a most efficient storage spot for the tote within storage structure 100. Also, in some embodiments, all vertical conveyors 1902 may not have access to all layers of the storage structure 100, such as in the case wherein certain layers are less deep than other layers, as shown in FIG. 36, and have access to a fewer number of vertical conveyors 1902. In such a case, a control system will choose the proper vertical conveyor 4002 to move the tote to a particular spot within storage structure 100.

### Placement of Vertical Conveyers

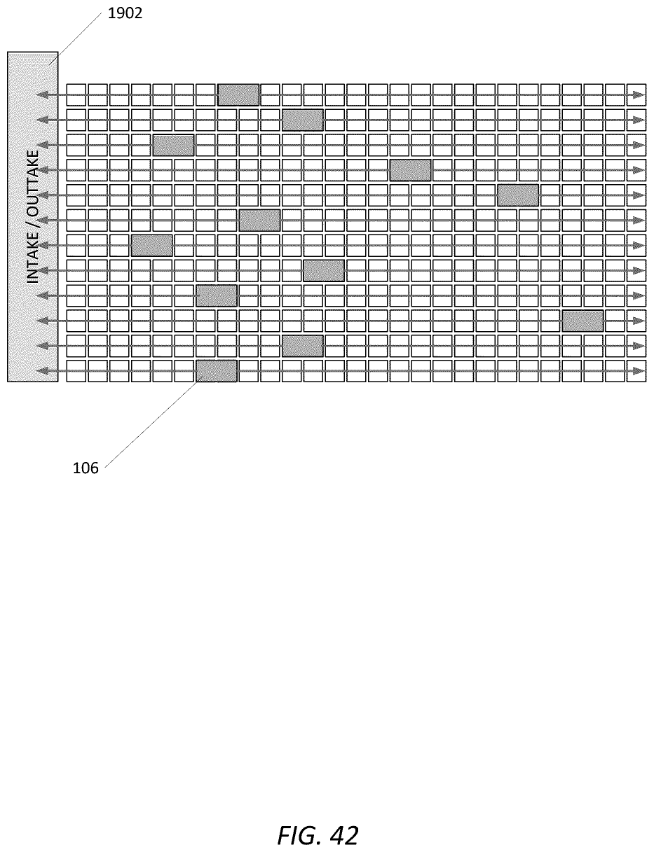

The number of vertical conveyors 1902 in the design of any particular implementation of storage structure 100 also affects the number of carriers that may be used per layer and, as such, the overall efficiency of the storage structure 100. FIG. 42 shows a view of storage structure 100 looking into the ends of the rows showing a minimal configuration utilizing only one vertical conveyor 1902 located at the end of the layers. In this configuration, each layer in storage structure 100 will be limited to one pair of carriers 106, unless the carriers are provided with the capability to perform carrier-to-carrier transfers of totes.

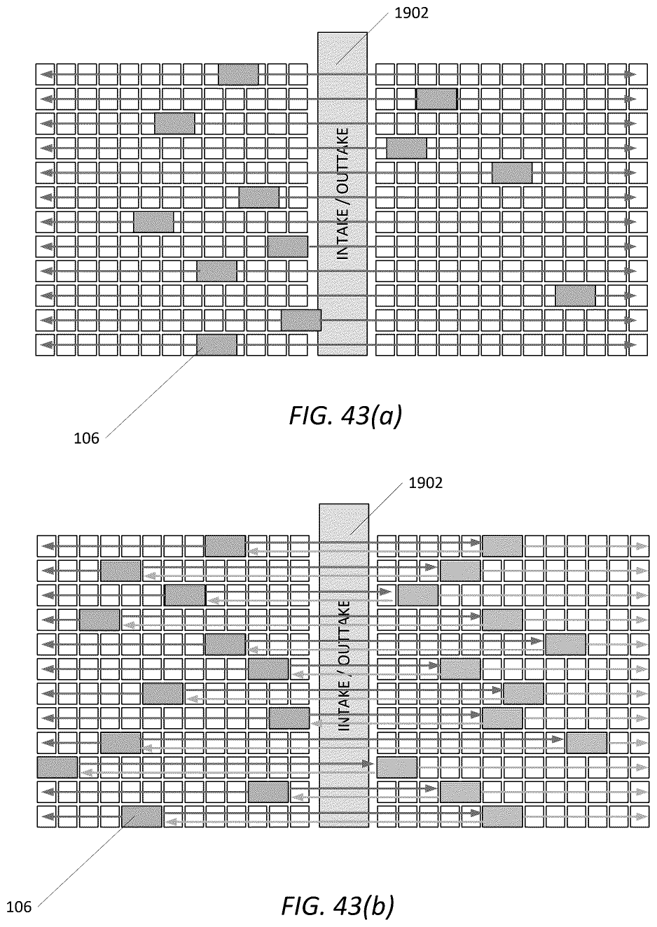

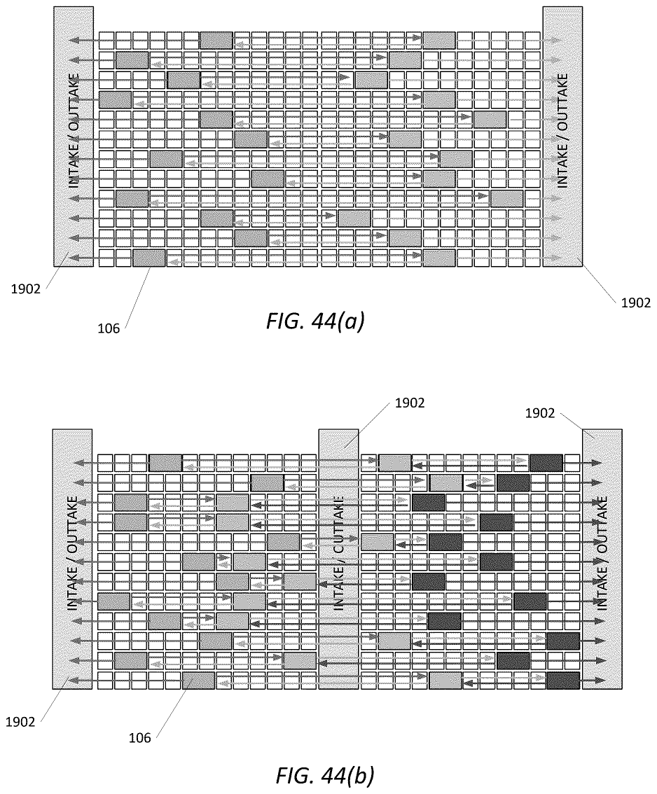

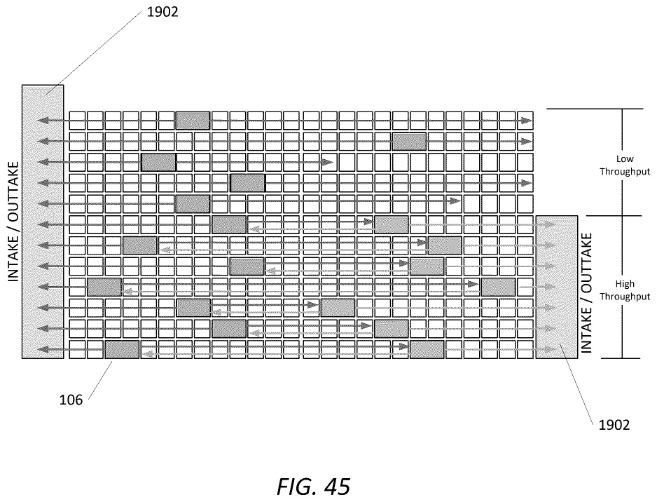

In an alternate single vertical conveyor embodiment, a vertical conveyor 1902 is deployed in the middle of the layers. In this configuration, each layer may be configured with one pair of carriers 106, shown in FIG. 43(A) or with or two pairs of carriers 106, as shown in FIG. 43(B). FIG. 44(A) shows an embodiment using two vertical conveyors 1902. In this embodiment, each layer is limited to two pairs of carriers 106, unless the carriers are provided with the capability of performing carrier-to-carrier transfers. FIG. 44(B) shows an embodiment having vertical conveyors 1902 located on each end of the rows in addition to a third vertical conveyor 1902 located in the middle of the rows. In this embodiment, each layer may be provided with up to four pairs of carriers 106. The advantage of having additional vertical conveyors servicing each layer is increased overall throughput of the system.

FIG. 45 shows yet another embodiment wherein vertical conveyors 1902 service different portions of storage structure 100. In the particular embodiment shown, the lower rows, because they have access to two vertical conveyors 1902, are able to be configured with two pairs of carriers 106 per layer. However, the top portion of the storage structure 100, which is only serviced by vertical carrier 1902 on the left side of the row is limited to one pair of carriers 106 per layer. As such, one storage strategy would be to store frequently accessed goods in totes on the lower levels of the storage structure, which may be able to provide a higher throughput, while storing less frequently accessed goods in totes in the higher layers of the storage structure having lower throughput. The same configuration would also apply to storage structures having layers of varying depths, as shown in FIG. 36. As would be realized by one of skill in the art, many different combinations of layers having various configurations and vertical conveyors having varying placements are possible and are still contemplated to be within the scope of the invention.

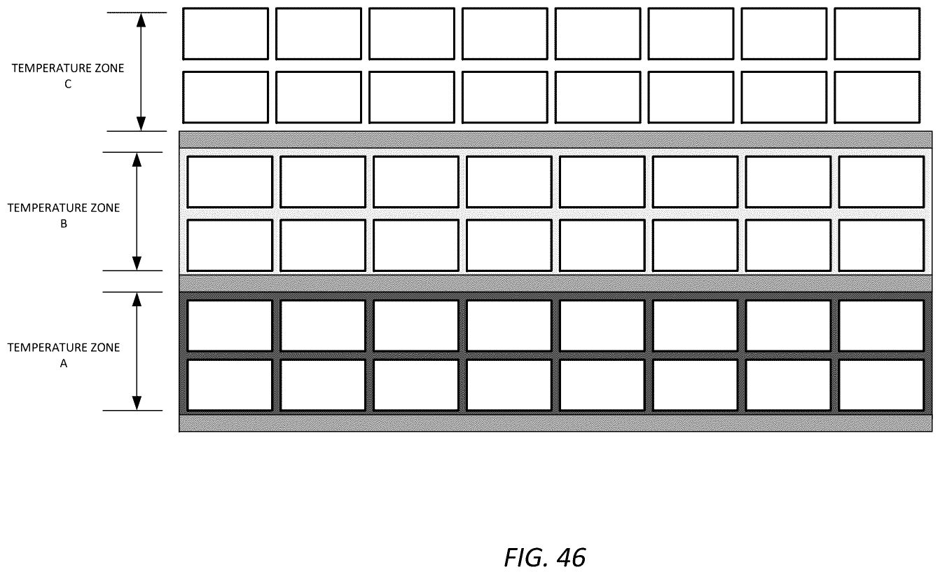

Many other variations and features of the storage structure may be provided. For example, FIG. 46 shows a configuration wherein various layers or rows of storage structure 100 are temperature controlled such as to provide, for example, a cooled storage environment for various types of goods. In such embodiments, each row or layer may be encased in an insulative material to prevent the bleeding of temperatures to other rows or layers in the structure. In addition, each row may be provided with a barrier at each end thereof which may be, for example, a mechanical door which opens as the totes are retrieved from or pushed into the row or a plastic sheet through which the totes may pass as they are pushed into or retrieved from the rows. In addition, in certain embodiments, the carriers 106 may also be temperature controlled and may live within the temperature controlled zones within storage structure 100. In that embodiment, carriers 106 may pass out of the temperature controlled zone to deliver or retrieve totes from the intake/output structure 108.

### Vertical Movement Embodiments

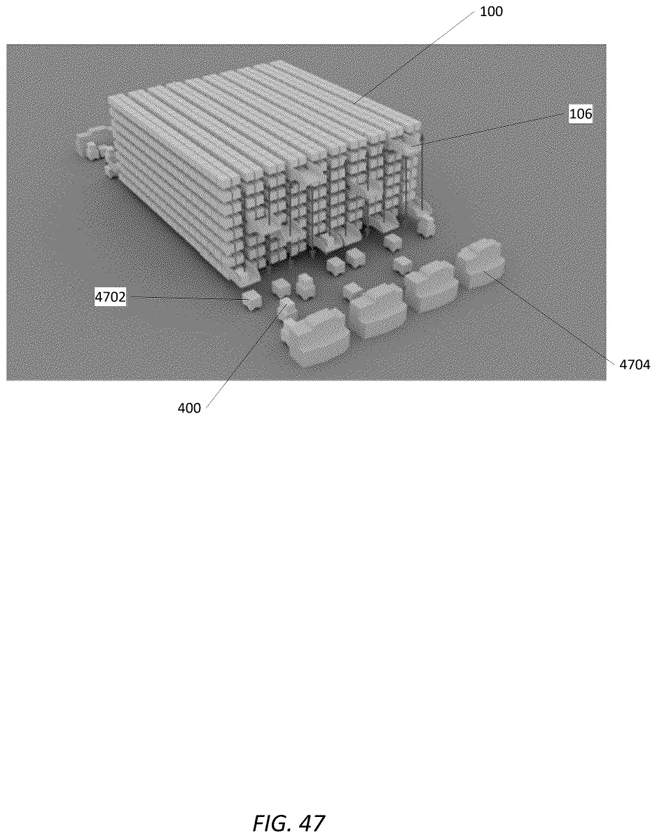

FIG. 47 shows a first embodiment of a vertically configured storage structure 100 wherein the robotic carriers 106 are configured to move vertically with respect to storage structure 100. Each carrier 106 is two or more columns wide such as to be able to handle two or more columns of rows of totes. In some embodiments, the carrier 106 may be any number of columns wide, from two columns wide to as wide as the total number of columns in storage structure 100. As with previous embodiments wherein carriers 106 are configured to move horizontally, a primary carrier 106 is deployed on one side of storage structure 100 and a secondary carrier 106 is deployed on an opposite side of storage structure 100, such as to enable the pair of carriers 106 to operate in tandem to circulate totes into and out of rows until a tote-of-interest is located on one of the robotic carriers 106. Note that a carrier 106 on either side of storage structure to 100 may act as the primary carrier or the secondary carrier. A tote-of-interest located in a source row of storage structure 100 can be retrieved and located on a carrier 106 by repeatedly moving totes from a source row in which the tote-of-interest is located to a destination row until the tote-of-interest is located on one of carriers 106, as previously described with respect to other embodiments. To circulate totes 400 until the tote-of-interest is located on a carrier 106, a tote 400 located at an end of the source row is moved from the source row onto a carrier 106 by a pulling motion by carrier 106. The tote 400 may then be shifted horizontally on carrier 106 to a position aligned with another row and pushed into the destination row. If the destination row was full, a tote 400 many pushed out of the opposite end of the destination row, whereupon it will be retrieved by the secondary carrier 106 and shifted on the secondary carrier 106 it is to be aligned with another row and storage structure 100. A tote 400 located on a carrier 106 may aligned with the destination row by shifting tote 400 from a first position on the carrier 106 to a second position on carrier 106 or by movement of the carrier 106 to the destination row such as to align tote 400 with the destination row.

Robotic carriers 106 in this embodiment are substantially identical to the carriers used in the configuration wherein the carriers 106 move horizontally with respect to storage structure 100 with the exception of the means by which the carriers 106 are attached to and move with respect to storage structure 100. In this embodiment, storage structure 100 may be configured with vertical rails to enable the vertical movement of carriers 106. Additionally, in one aspect of this embodiment, carriers 106 may have the ability to transfer a tote 400 from one carrier 106 to another carrier 106 on the same side of the storage structure 100 and aligned in the same vertical layer of storage structure 100. In another aspect of this embodiment, carriers 106 for adjacent sets of columns may be mechanically coupled to each other such as to reduce the number of actuators needed to move carriers 106 vertically.

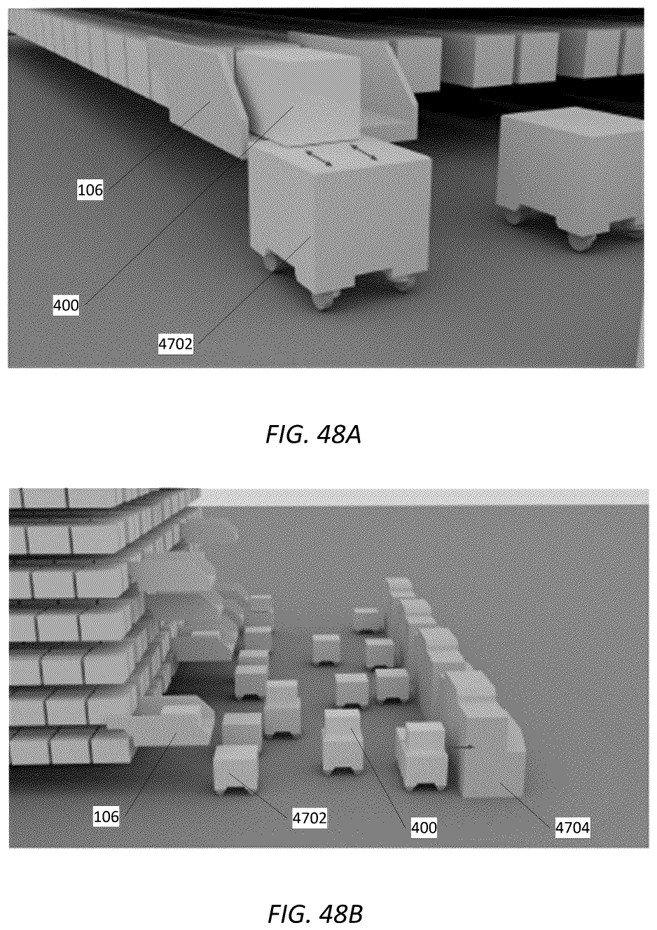

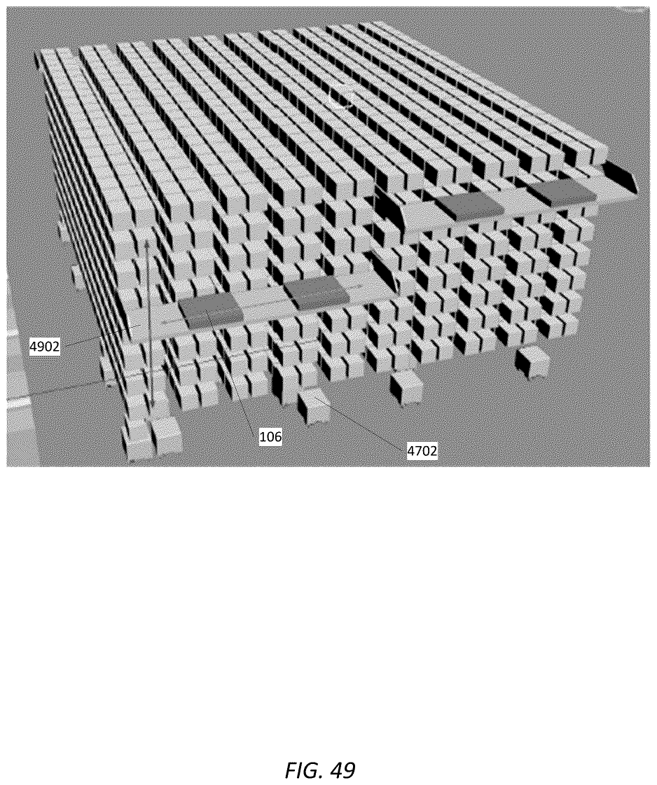

Once a tote-of-interest is located on a carrier 106, the carrier must move vertically to transport the tote-of-interest to an exit point of storage structure 100. In one embodiment, the exit point of the system may comprise a plurality of automated mobile robots 4702 which may accept a tote-of-interest from carrier 106 and transport the tote-of-interest to a picking station 4704. As shown in FIGS. 48(A,B) it is necessary that carrier 106 be able to move totes onto and off of carrier 106 in either lateral direction (i.e., in a direction aligned with a lateral axis of the rows of storage structure 100). In the embodiment wherein automated mobile robots 4702 are used, the robots may be located at any level of storage structure 100. For example, in one embodiment, storage structure 100 may be recessed into a structure and the automated mobile robots 4702 could be located on a platform at the top layer of storage structure 100. An embodiment wherein automated mobile robots 4702 are able to move underneath storage structure 100 and accept a tote 400 from a carrier 106 while located underneath storage structure 100, as shown in FIG. 49, is also within the scope of the invention.

In another embodiment, the exit point of storage structure 100 consists of one or more horizontal conveyors located at one or more different vertical positions with respect to storage structure 100. The conveyors may be similar or identical to carriers 2402 shown in FIGS. 24, 25, 26(A-G) and 27(A-E). To facilitate movement of totes 400 from carriers 106 to a conveyor 2402, in this embodiment, it is also necessary that carrier 106 be able to onload and offload totes 400 from carrier 106 in both lateral directions. In an embodiment wherein multiple conveyors 2402 are located at multiple vertical heights with respect to storage structure 100, it is contemplated that multiple carriers 106 may be deployed in the same columns of storage structure 100. For example, if storage structure 100 has conveyors 2402 located at four different vertical levels with respect storage structure 100, it is possible to have up to four carriers 106 covering the same vertical columns of storage structure 100. Conveyors 2402 can move totes 400 to an intake/output system consisting either of a type described herein or any other type.

FIG. 49 shows a second embodiment of a vertically configured storage structure 100 wherein storage structure 100 is configured with one or more vertical platforms 4902. Vertical platforms 4902 are configured to move vertically with respect to storage structure 100. Each vertical platform 4902 is at least two columns wide and may be as wide as a single layer of storage structure 100. Vertical platforms 4902 are deployed on opposite sides of storage structure 100.

Each vertical platform 4902 will have deployed thereon one or more robotic carriers 106 capable of moving horizontally along vertical platform 4902. Robotic carriers 106 operate as described with respect to the embodiment of FIG. 47 but are not attached to storage structure 100. Instead, vertical platforms 4902 may be configured with rails or other means configured to allow carriers 106 to move horizontally on vertical platform 4902. The only difference between the embodiment described with respect to FIG. 47 and the embodiment of FIG. 49 is that the vertical movement in the embodiment of FIG. 49 is provided by vertical platform 4902, instead of having carriers 106 move vertically. In one aspect of the invention, both vertical movement embodiments, that is, vertical carriers 106 and vertical platforms 4902, may be present on the same storage structure 100.

1. A storage structure comprising:
a plurality of rows, arranged in lateral layers and vertical columns, storing a plurality of totes; and
one or more vertical robotic carriers, each vertical robotic carrier being two or more columns wide and moving vertically along the storage structure;
wherein each vertical robotic carrier supports one or more lateral robotic carriers able to move laterally along the vertical robotic carrier.

2. The storage structure of claim 1:
wherein the one or more vertical robotic carriers comprise a first set of vertical robotic carriers deployed on a first end of the storage structure and a second set of vertical robotic carriers deployed on a second, opposite end of the storage structure.

3. The storage system of claim 2:
wherein a tote-of-interest is located on a lateral robotic carrier on a vertical robotic carrier;
wherein the vertical robotic carrier moves vertically to one of one or more predetermined levels of the storage structure; and
wherein the lateral robotic carrier on the vertical robotic carrier moves the tote-of-interest from the lateral robotic carrier to an intake/output system.

4. The storage structure of claim 2:
wherein the one or more vertical robotic carriers comprises a first set of vertical robotic carriers deployed on a first end of the storage structure and a second set of vertical robotic carriers deployed on a second, opposite end of the storage structure; and
a lateral robotic carrier deployed on a vertical robotic carrier from the first set of vertical robotic carriers and a lateral robotic carrier deployed on a vertical robotic carrier from the second set of vertical robotic carriers operate as a pair to move totes from a source row in a column to a destination row in the same or a different column until the tote-of-interest is located on a lateral robotic carrier.

5. The storage structure of claim 1:
wherein a first vertical robotic carrier from the first set of vertical robotic carriers vertically aligns on a level of the storage structure with a second vertical robotic carrier from the second set of vertical robotic carriers;
wherein a lateral robotic carrier on the first vertical robotic carrier pulls on a tote from a first end of a source row in a first column onto the lateral robotic carrier;
wherein the lateral robotic carrier moves the tote into alignment with a destination row in a second column; and
wherein the lateral robotic carrier pushes the tote into the destination row in the second column.

6. The storage system of claim 5:
wherein the lateral robotic carrier shifts the tote from a first position on the lateral robotic carrier aligned with the source row to a second position on the lateral robotic carrier aligned with the destination row.

7. The storage structure of claim 6:
wherein shifting the tote from alignment with the source row to alignment with the destination row causes the tote to become automatically decoupled from other totes in the source row.

8. The storage structure of claim 6:
wherein movement of the tote in a direction orthogonal to a longitudinal axis of the source row on the lateral robotic carrier causes the tote to become automatically decoupled from other totes in the source row.

9. The storage system of claim 5:
wherein the lateral robotic carrier moves along the vertical robotic carrier to align the tote with the destination row.

10. The storage structure of claim 6:
wherein the tote at the first end of the source row in a first column is longitudinally coupled to one or more other totes in the source row such that the pulling motion on the first tote by the lateral robotic carrier causes the other coupled totes in the source row to move longitudinally in the row toward the lateral robotic carrier.

11. The storage structure of claim 10:
wherein totes are repeatedly pulled from the source row onto the lateral robotic carrier and deposited in to the destination row until the tote-of-interest is located on the lateral robotic carrier.

12. The storage structure of claim 11:
wherein a single gap of one or more tote lengths exists in the destination row, dividing the destination row into a first segment of totes located at the first end of the storage structure and a second segment of totes located at the second end of the storage structure opposite the first end; and
wherein repeatedly pushing a tote into a first end of the destination row causes the gap to be reduced by one tote-length until the first and second segments become coupled together.

13. The storage structure of claim 11:
wherein the destination row is full of totes such that pushing a first tote into the first end of the destination row by the lateral robotic carrier on the first vertical carrier causes a second tote to be pushed out of the second end of the destination row and on to a lateral robotic carrier deployed on a second vertical robotic carrier;
wherein the lateral robotic carrier deployed on a second vertical robotic carrier shifts the second tote on the lateral robotic carrier to be aligned with a row in another column; and
wherein the second lateral robotic carrier pushes the tote into the row in the other column.

14. The storage structure of claim 13:
wherein the row in the other column is the source row.

15. The storage structure of claim 3:
wherein the intake/output system comprises a plurality of automated mobile robots; and
wherein movement of the tote-of-interest from the lateral robotic carrier to the intake/output system comprises movement of the vertical robotic carrier to one of the predetermined levels and movement of the tote in a direction aligned with the longitudinal axis of the rows from the lateral robotic carrier and onto one of the plurality of automated mobile robots.

16. The storage structure of a claim 15 wherein:
the predetermined level at which the intake/output system is located is a level lower than the lowest level of the storage structure; and
the automated mobile robots are able to move underneath the storage structure and can accept a tote from a lateral robotic carrier while underneath the structure.

17. The storage structure of claim 3:
wherein the intake/output system comprises one or more conveyors located at the one or more predetermined levels; and
wherein movement of the tote-of-interest from a lateral robotic carrier to the intake/output system comprises movement of the tote in a direction aligned with the longitudinal axis of the rows and onto one of the one or more conveyors.

18. The storage system of claim 15:
wherein conveyors are located at one or more of the predetermined levels of the storage structure; and
wherein multiple vertical robotic carriers are deployed in the same columns of the storage structure.

19. The storage structure of claim 1 wherein the one or more vertical robotic carriers move only vertically with respect to the storage structure.

20. The storage structure of claim 1 wherein the vertical robotic carriers are as wide as the plurality of columns in the storage structure.
